(19) United States
(12) Patent Application Publication
(10) Pub. No.: US 2026/0271001 A1
(43) Pub. Date: Sep. 10, 2026

(54) METHOD, USER EQUIPMENT, AND BASE STATION FOR CG PUSCH TRANSMISSIONS

(71) Applicant: SHARP KABUSHIKI KAISHA, Sakai City, Osaka (JP)

(72) Inventor: CHIA-HSIN LAI, Taipei (TW)

(21) Appl. No.: 19/115,578

(22) PCT Filed: Sep. 28, 2023
(86) PCT No.: PCT/CN2023/122761

§ 371 Date: Mar. 26, 2025

Related U.S. Application Data
(60) Provisional application No. 63/411,430, filed on Sep. 29, 2022.
(60) Provisional application No. 63/411,432, filed on Sep. 29, 2022.

(51) Int. Cl. H04W 72/21

(52) U.S. Cl. CPC H04W 72/21

(57) ABSTRACT

A method for configured grant (CG) physical uplink shared channel (PUSCH) transmissions performed by a user equipment (UE) is provided. The method includes receiving, from a base station (BS), a configuration corresponding to a plurality of CG PUSCH occasions; and transmitting, to the BS, one or more CG PUSCHs on one or more CG PUSCH occasions of the plurality of CG PUSCH occasions. Uplink control information (UCI) is multiplexed in each of the one or more CG PUSCHs, and each UCI indicates whether subsequent CG PUSCH occasions are unused or used by the UE.

### CROSS-REFERENCE TO RELATED APPLICATION(S)

The present disclosure claims the benefit of and priority to U.S. Provisional Patent Application Ser. No. 63/411,432, filed on Sep. 29, 2022, entitled “METHOD AND APPARATUS TO ENHANCE UPLINK CONFIGURATION WITH CONFIGURED GRANT” (“the '432 provisional”) and U.S. Provisional Patent Application Ser. No. 63/411,430, filed on Sep. 29, 2022, entitled “METHOD AND APPARATUS TO ENHANCE ACTIVATION AND DEACTIVATION OF UPLINK CONFIGURATION WITH CONFIGURED GRANT” (“the '430 provisional”). The contents of the '432 provisional and the '430 provisional are hereby incorporated herein fully by reference into the present disclosure for all purposes.

### FIELD

The present disclosure is related to wireless communication and, more specifically, to a method, a user equipment (UE), and a base station (BS) for configured grant (CG) physical uplink shared channel (PUSCH) transmissions in cellular wireless communication networks.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a method, a user equipment (UE), and a base station (BS) for configured grant (CG) physical uplink shared channel (PUSCH) transmissions in cellular wireless communication networks.

In a first aspect of the present application, a method for configured grant (CG) physical uplink shared channel (PUSCH) transmissions performed by a UE is provided. The method includes receiving, from a base station (BS), a configuration corresponding to a plurality of CG PUSCH occasions; and transmitting, to the BS, one or more CG PUSCHs on one or more CG PUSCH occasions of the plurality of CG PUSCH occasions. Uplink control information (UCI) is multiplexed in each of the one or more CG PUSCHs, and each UCI indicates whether subsequent CG PUSCH occasions are unused or used by the UE.

In an implementation of the first aspect, the each UCI includes a bitmap indicating whether the subsequent CG PUSCH occasions are unused or used by the UE.

In another implementation of the first aspect, the configuration includes a parameter applied for the each UCI, and the each UCI indicates, based on the parameter, whether a number of the subsequent CG PUSCH occasions are unused or used by the UE.

In another implementation of the first aspect, a beta-offset is configured for each of the one or more CG PUSCHs, and the UCI is multiplexed in each of the one or more CG PUSCHs based on the beta-offset.

In another implementation of the first aspect, the beta-offset configured for each of the one or more CG PUSCHs is different.

In a second aspect of the present application, a UE for configured grant (CG) physical uplink shared channel (PUSCH) transmissions is provided. The UE includes one or more processors and at least one memory coupled to at least one of the one or more processors, the at least one memory storing computer-executable instructions that, when executed by the at least one of the one or more processors, cause the UE to receive, from a base station (BS), a configuration corresponding to a plurality of CG PUSCH occasions; and transmit, to the BS, one or more CG PUSCHs on one or more CG PUSCH occasions of the plurality of CG PUSCH occasions. Uplink control information (UCI) is multiplexed in each of the one or more CG PUSCHs, and each UCI indicates whether subsequent CG PUSCH occasions are unused or used by the UE.

In a third aspect of the present application, a BS for configured grant (CG) physical uplink shared channel (PUSCH) transmissions is provided. The BS includes one or more processors and at least one memory coupled to at least one of the one or more processors, the at least one memory storing computer-executable instructions that, when executed by the at least one of the one or more processors, cause the BS to transmit, to a user equipment (UE), a configuration corresponding to a plurality of CG PUSCH occasions; and receive, from the UE, one or more CG PUSCHs on one or more CG PUSCH occasions of the plurality of CG PUSCH occasions. Uplink control information (UCI) is multiplexed in each of the one or more CG PUSCHs, and each UCI indicates whether subsequent CG PUSCH occasions are unused or used by the UE.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method for CG PUSCH transmissions performed by a UE, according to an example implementation of the present disclosure.

FIG. 2 is a flowchart illustrating a method for CG PUSCH transmissions performed by a BS, according to an example implementation of the present disclosure.

FIG. 3 is a block diagram illustrating a node for wireless communication, according to an example implementation of the present disclosure.

### DESCRIPTION

Some abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AL | Aggregation Level |
| BA | Bandwidth Adaptation |
| BFD | Beam Failure Detection |
| BFR | Beam Failure Recovery |
| BS | Base Station |
| BSR | Buffer Status Report |
| BW | Bandwidth |
| BWP | Bandwidth Part |
| CA | Carrier Aggregation |
| CBG | Code Block Group |
| CC | Component Carrier |
| CCCH | Common Control Channel |
| CCE | Control Channel Elements |
| CE | Control Element |
| CG | Configured Grant |
| CH | Channel |
| CJT | Coherent Joint Transmission |
| CORESET | Control Resource Set |
| CP | Cyclic Prefix |
| CRC | Cyclic Redundancy Check |
| CSI | Channel State Information |
| CSI-RS | Channel State Information Reference Signal |
| CSS | Common Search Space |
| DC | Dual Connectivity |
| DCI | Downlink Control Information |
| DCP | DCI with CRC scrambled by PS-RNTI |
| DFI | Downlink Feedback Information |
| DL | Downlink |
| DM-RS | Demodulation Reference Signal |
| DRX | Discontinuous Reception |
| E-UTRA | Evolved Universal Terrestrial Radio Access |
| FDM | Frequency Division Multiplexing |
| FR | Frequency Range |
| HARQ | Hybrid Automatic Repeat Request |
| HARQ-ACK | HARQ Acknowledgement |
| ID | Identifier |
| IE | Information Element |
| LBT | Listen Before Talk |
| LSB | Least Significant Bit |
| LTE | Long Term Evolution |
| MAC | Medium Access Control |
| MAC CE | MAC Control Element |
| MCG | Master Cell Group |
| MCS | Modulation Coding Scheme |
| MN | Master Node |
| MSB | Most Significant Bit |
| NR | New Radio |
| NR-U | New Radio Unlicensed |
| NW | Network |
| OFDM | Orthogonal Frequency Division Multiplexing |
| PBCH | Physical Broadcast Channel |
| PCell | Primary Cell |
| PCI | Physical Cell ID |
| PDCCH | Physical Downlink Control Channel |
| PDCP | Packet Data Convergence Protocol |
| PDSCH | Physical Downlink Shared Channel |
| PHR | Power Headroom Report |
| PHY | Physical (layer) |
| PSCell | Primary SCG Cell |
| PTRS | Phase Tracking Reference signal |
| PUCCH | Physical Uplink Control Channel |
| PUSCH | Physical Uplink Shared Channel |
| QCL | Quasi-CoLocation |
| RA | Random Access |
| RAN | Radio Access Network |
| RAR | Random Access Response |
| Rel | Release |
| RF | Radio Frequency |
| RLC | Radio Link Control |
| RNTI | Radio Network Temporary Identifier |
| RRC | Radio Resource Control |
| RS | Reference Signal |
| RX | Reception |
| SCell | Secondary Cell |
| SCG | Secondary Cell Group |
| SCS | Subcarrier Spacing |
| SFN | Single Frequency Network |
| SI | System Information |
| SL | Sidelink |
| SLIV | Start and Length Indicator Value |
| SN | Secondary Node |
| SpCell | Special Cell |
| SPS | Semi-Persistent Scheduling |
| SR | Scheduling Request |
| SRI | SRS Resource Indicator |
| SRS | Sounding Reference Signal |
| SS | Search Space |
| SSB | Synchronization Signal Block |
| TA | Timing Advance |
| TB | Transport Block |
| TBG | Transport Block Group |
| TCI | Transmission Configuration Indication |
| TDM | Time Division Multiplexing |
| TDRA | Time Domain Resource Allocation |
| TR | Technical Report |
| TRP | Transmission Reception Point |
| TRS | Tracking Reference Signal |
| TS | Technical Specification |
| TX | Transmission |
| UCI | Uplink Control Information |
| UE | User Equipment |
| UL | Uplink |
| URLLC | Ultra Reliable Low Latency Communication |
| USS | UE-specific search space |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

It should be noted that the term ‘TRP’ in the present disclosure may be replaced by ‘beam’ or ‘panel’. It should be noted that the term ‘overlap’ may refer to time domain overlapping.

Examples of some selected terms in the present disclosure are provided as follows.

User Equipment (UE): The UE may be referred to as the PHY/MAC/RLC/PDCP/SDAP entity. The PHY/MAC/RLC/PDCP/SDAP entity may be referred to as the UE.

Network (NW): The NW may be a network node, a TRP, a cell (e.g., Special Cell (SpCell), PCell, PSCell, and/or SCell), an eNB, a gNB, and/or a base station.

Serving Cell: The serving cell may be referred to as a Primary Cell (PCell), a PSCell, or a Secondary Cell (SCell). The serving cell may be an activated or a deactivated serving cell.

Special Cell (SpCell): For Dual Connectivity operation, the Special Cell may be referred to as the PCell of the Master Cell Group (MCG) or the PSCell of the Secondary Cell Group (SCG) depending on whether the MAC entity is associated with the MCG or the SCG. Otherwise, the Special Cell may be referred to as the PCell. A Special Cell may support PUCCH transmission and contention-based Random Access, and may be always activated.

In the following, the resource allocation for the uplink transmission with the configured grant is introduced.

When a PUSCH resource allocation is semi-statically configured by the higher layer parameter configuredGrantConfig in BWP-UplinkDedicated information element (IE) and the PUSCH transmission corresponds to a configured grant, the following higher layer parameters may be applied in the transmission.

For Type 1 PUSCH transmissions with a configured grant, the following parameters may be provided in configuredGrantConfig unless mentioned otherwise:
(a) For the determination of the PUSCH repetition type, if the higher layer parameter pusch-RepTypeIndicator in rrc-ConfiguredUplinkGrant is configured and set to ‘pusch-RepTypeB’, the PUSCH repetition type B may be applied; otherwise, the PUSCH repetition type A may be applied.

For PUSCH repetition type A, the selection of the time domain resource allocation table may follow the rules for DCI format 0_0 on UE specific search space, as specified in the 3GPP TS 38.214.

For PUSCH repetition type B, the selection of the time domain resource allocation table may be as follows. If pusch-RepTypeIndicatorDCI-0-1 in pusch-Config is configured and set to ‘pusch-RepTypeB’, pusch-TimeDomainAllocationListDCI-0-1 in pusch-Config may be used; otherwise, pusch-TimeDomainAllocationListDCI-0-2 in pusch-Config may be used. It may not be expected that pusch-RepTypeIndicator in rrc-ConfiguredUplinkGrant is configured with ‘pusch-RepTypeB’ when none of pusch-RepTypeIndicatorDCI-0-1 and pusch-RepTypeIndicatorDCI-0-2 in pusch-Config is set to ‘pusch-RepTypeB’.
(b) The higher layer parameter timeDomainAllocation value m may provide a row index m+1 pointing to the determined time domain resource allocation table, where the start symbol and length may be determined following the procedure as specified in the 3GPP TS 38.214.
(c) Frequency domain resource allocation may be determined by the N LSB bits in the higher layer parameter frequencyDomainAllocation, forming a bit sequence f₁₇, . . . , f₁, f₀, where f₀ is the LSB, according to the procedure as specified in the 3GPP TS 38.214 and N is determined as the size of frequency domain resource assignment field in DCI format 0_1 for a given resource allocation type indicated by resourceAllocation.
(d) The I_{MCS} may be provided by the higher layer parameter mcsAndTBS.
(e) When (i) two SRS resource sets are configured in srs-ResourceSetToAddModList or srs-ResourceSetToAddModListDCI-0-2, (ii) precoding information and number of layers (applicable when higher layer parameter usage in SRS-ResourceSet set to ‘codebook’) associated with the first and second SRS resource set is provided by precodingAndNumberOfLayers and precodingAndNumberOfLayers2, respectively, and (iii) SRS resource indicators associated with the first and second SRS resource sets are provided by srs-ResourceIndicator and srs-ResourceIndicator2, respectively, number of DM-RS CDM groups, DM-RS ports, SRS resource indication and DM-RS sequence initialization may be determined as specified in the 3GPP TS 38.212, and the antenna port value, the bit value for DM-RS sequence initialization, precoding information and number of layers, SRS resource indicator may be provided by antennaPort, dmrs-SeqInitialization, precodingAndNumberOfLayers, and srs-ResourceIndicator respectively. When both srs-ResourceSetToAddModList and srs-ResourceSetToAddModListDCI-0-2 are configured with two SRS resource sets, the two SRS resource sets configured by srs-ResourceSetToAddModList may be used to determine the SRS resource indications by srs-ResourceIndicator and srs-ResourceIndicator2.

If two SRS resource sets with usage set to ‘codebook’ or ‘noncodebook’ are configured in srs-ResourceSetToAddModList, the two SRS resource sets may be used to determine the SRS resource indications by srs-ResourceIndicator and srs-ResourceIndicator2. Otherwise, the two SRS resource sets with usage set to ‘codebook’ or ‘noncodebook’ configured in srs-ResourceSetToAddModListDCI-0-2 may be used to determine the SRS resource indications by srs-ResourceIndicator and srs-ResourceIndicator2.
(f) When frequency hopping is enabled, the frequency offset between two frequency hops may be configured by the higher layer parameter frequencyHoppingOffset.

For Type 2 PUSCH transmissions with a configured grant, the resource allocation may follow the higher layer configuration as specified in the 3GPP TS 38.321, and UL grant received on the DCI.

The PUSCH repetition type and the time domain resource allocation table may be determined by the PUSCH repetition type and the time domain resource allocation table associated with the UL grant received on the DCI, respectively, as specified in the 3GPP TS 38.214. The value of K_{offset}, if configured, may be applied when determining the first transmission opportunity.

For PUSCH transmissions with a Type 1 or Type 2 configured grant, the number of (nominal) repetitions K to be applied to the transmitted transport block may be provided by the indexed row in the time domain resource allocation table if numberOfRepetitions is present in the table. Otherwise, K may be provided by the higher layer configured parameters repK.

For PUSCH transmissions with a Type 2 configured grant, when two SRS resource sets are configured in srs-ResourceSetToAddModList or srs-ResourceSetToAddModListDCI-0-2, the SRS resource set associated with (nominal) repetitions may follow MappingPattern in ConfiguredGrantConfig as specified in the 3GPP TS 38.214 for PUSCH scheduled by DCI format 0_1 and 0_2. For PUSCH transmissions with a Type 1 configured grant, when two SRS resource sets with usage set to ‘codebook’ or ‘noncodebook’ are configured in srs-ResourceSetToAddModList or srs-ResourceSetToAddModListDCI-0-2, and two SRS resource indicators and two precoding information are provided, the SRS resource set associated with (nominal) repetitions may be determined as follows.

When K=2, the first and second SRS resource sets may be applied to the first and second (nominal) repetitions, respectively. When K>2 and cyclicMapping in ConfiguredGrantConfig is enabled, the first and second SRS resource sets may be applied to the first and second (nominal) repetitions, respectively, and the same SRS resource set mapping pattern may continue to the remaining (nominal) repetitions. When K>2 and sequentialMapping in ConfiguredGrantConfig is enabled, the first SRS resource set may be applied to the first and second (nominal) repetitions, and the second SRS resource set may be applied to the third and fourth (nominal) repetitions, and the same SRS resource set mapping pattern may continue to the remaining (nominal) repetitions.

For PUSCH transmissions with a Type 1 configured grant, when two SRS resource sets are configured in srs-ResourceSetToAddModList or srs-ResourceSetToAddModListDCI-0-2, and configuredGrantConfig contains only one pathlossReferencelndex, p0-PUSCH-Alpha, powerControlLoopToUse, srs-ResourceIndicator and precodingAndNumberOfLayers (applicable when higher layer parameter usage in SRS-ResourceSet set to ‘codebook’), PUSCH repetitions may be only associated with the first SRS resource set.

For a retransmission of a configured grant Type 1 PUSCH, or for activation or retransmission of a configured grant Type 2 PUSCH, scheduled by a DCI format that includes an SRS resource set indicator field, if the UE is provided two SRS resource sets in srs-ResourceSetToAddModList or srs-ResourceSetToAddModListDCI-0-2 with usage set to ‘codebook’ or ‘nonCodebook’, and the UE is not provided p0-PUSCH-Alpha2 and powerControlLoopToUse2, the UE may expect the value of the SRS resource set indicator field is set to ‘00’, and PUSCH repetitions may be only associated with the first SRS resource set.

The UE may not transmit anything on the resources configured by configuredGrantConfig if the higher layers did not deliver a transport block to transmit on the resources allocated for uplink transmission without a grant.

A set of allowed periodicities P may be defined as specified in the 3GPP TS 38.331. The higher layer parameter cg-nrofSlots may provide the number of consecutive slots allocated within a configured grant period. The higher layer parameter cg-nrofPUSCH-InSlot may provide the number of consecutive PUSCH allocations within a slot, where the first PUSCH allocation may follow (i) the higher layer parameter timeDomainAllocation for Type 1 PUSCH transmission or the higher layer configuration as specified in the 3GPP TS 38.321, and (ii) UL grant received on the DCI for Type 2 PUSCH transmissions. The remaining PUSCH allocations have the same length and PUSCH mapping type, and are appended following the previous allocations without any gaps. The same combination of start symbol and length and PUSCH mapping type may repeat over the consecutively allocated slots.

For operations involving shared spectrum channel access, when the higher layer parameter ue-SemiStaticChannelAccessConfig is not configured and the UE is performing an uplink transmission with configured grants in contiguous OFDM symbols on all resource blocks of an RB set, the UE may determine the duration of a cyclic prefix extension Tₑₓₜ to be applied for the first such UL transmission, as specified in the 3GPP TS 38.211, and the index Δᵢ as specified in the 3GPP TS 38.211 is randomly selected from a set of values configured by higher layers based on the following rule:

If the first such UL transmission is within a channel occupancy initiated by the gNB (as specified in the 3GPP TS 37.213), the set of values may be determined by cg-StartingFullBW-InsideCOT. Otherwise, the set of values may be determined by cg-StartingFullBW-OutsideCOT.

For operations involving shared spectrum channel access, when the higher layer parameter ue-SemiStaticChannelAccessConfig is not configured and the UE is performing an uplink transmission with configured grants on contiguous OFDM symbols but on fewer than all resource blocks of an RB set, the UE may determine the duration of a cyclic prefix extension Tet to be applied for the first such UL transmission as specified in the 3GPP TS 38.211 based on the following rule:

If the first such UL transmission is within a channel occupancy initiated by the gNB (as specified in the 3GPP TS 37.213), the index for Δᵢ as specified in the 3GPP TS 38.211 may be equal to cg-StartingPartialBW-InsideCOT. Otherwise, the index for Δᵢ as specified in the 3GPP TS 38.211 may be equal to cg-StartingPartialBW-OutsideCOT.

Table 1 below shows an example of applicable PUSCH time domain resource allocation for common search space and DCI format 00 in UE specific search space.

TABLE 1

| | PDCCH | pusch-ConfigCommon | pusch-Config includes | PUSCH time domain |
|---|---|---|---|---|
| | search | includes pusch- | pusch- | resource allocation to |
| RNTI | space | TimeDomainAllocationList | TimeDomainAllocationList | apply |
| PUSCH scheduled | | No | — | Default A |
| by MAC RAR as | | Yes | | pusch- |
| specified in the | | | | TimeDomainAllocationList |
| 3GPP TS 38.213 or | | | | provided in pusch- |
| MAC fallbackRAR | | | | ConfigCommon |
| as specified in the | | | | |
| 3GPP TS 38.213 or | | | | |
| for MsgA PUSCH | | | | |
| transmission | | | | |
| C- | Any | No | — | Default A |
| RNTI, | common | Yes | | pusch- |
| MCS- | search | | | TimeDomainAllocationList |
| C- | space | | | provided in pusch- |
| RNTI, | associated | | | ConfigCommon |
| TC- | with | | | |
| RNTI, | CORESET | | | |
| CS- | 0 | | | |
| RNTI | | | | |
| C- | Any | No | No | Default A |
| RNTI, | common | Yes | No | pusch- |
| MCS- | search | | | TimeDomainAllocationList |
| C- | space not | | | provided in pusch- |
| RNTI, | associated | | | ConfigCommon |
| TC- | with | No/Yes | Yes | pusch- |
| RNTI, | CORESET | | | TimeDomainAllocationList |
| CS- | 0, | | | provided in pusch-Config |
| RNTI | DCI | | | |
| | format 0_0 | | | |
| | in | | | |
| | UE | | | |
| | specific | | | |
| | search | | | |
| | space | | | |

Table 2 below shows an example of applicable PUSCH time domain resource allocation for DCI format 01 in UE specific search space scrambled with C-RNTI, MCS-C-RNTI, CS-RNTI or SP-CSI-RNTI.

TABLE 2

| | | | pusch-Config | |
|---|---|---|---|---|
| | | | includes pusch- | |
| | | | TimeDomainAllocationList- | |
| pusch- | pusch-Config | | ForMultiPUSCH | |
| ConfigCommon | includes | pusch-Config | or pusch-Config | |
| includes | pusch- | includes pusch- | includes pusch- | PUSCH time domain |
| pusch- | TimeDomainAllo- | TimeDomainAllo- | TimeDomainAllo- | resource allocation |
| TimeDomainAllocationList | cationList | cationListDCI-0-1 | cationListForMultiPUSCH-17 | to apply |
| No | No | No | No | Default A |
| Yes | No | No | No | pusch- |
| | | | | TimeDomainAllocationList |
| | | | | provided in pusch- |
| | | | | ConfigCommon |
| No/Yes | Yes | No | No | pusch- |
| | | | | TimeDomainAllocationList |
| | | | | provided in pusch- |
| | | | | Config |
| No/Yes | No | Yes | — | pusch- |
| | | | | TimeDomainAllocationListDCI- |
| | | | | 0-1 provided |
| | | | | in pusch-Config |
| No/Yes | No/Yes | — | Yes | pusch- |
| | | | | TimeDomainAllocationList- |
| | | | | ForMultiPUSCH |
| | | | | or pusch- |
| | | | | TimeDomainAllocationListForMultiPUSCH - |
| | | | | 17 provided in pusch- |
| | | | | Config |

Table 3 below shows an example of applicable PUSCH time domain resource allocation for DCI format 0_2 in UE specific search space scrambled with C-RNTI, MCS-C-RNTI, CS-RNTI or SP-CSI-RNTI.

TABLE 3

| pusch- | | pusch-Config includes | |
|---|---|---|---|
| ConfigCommon | pusch-Config | pusch- | PUSCH time domain |
| includes pusch- | includes pusch- | TimeDomainAllocationListDCI- | resource allocation |
| TimeDomainAllocationList | TimeDomainAllocationList | 0-2 | to apply |
| No | No | No | Default A |
| Yes | No | No | pusch- |
| | | | TimeDomainAllocationList |
| | | | provided in pusch- |
| | | | ConfigCommon |
| No/Yes | Yes | No | pusch- |
| | | | TimeDomainAllocationList |
| | | | provided in pusch- |
| | | | Config |
| No/Yes | No | Yes | pusch- |
| | | | TimeDomainAllocationListDCI- |
| | | | 0-2 provided in |
| | | | pusch-Config |

Table 4 below shows an example of default PUSCH time domain resource allocation A for normal CP.

TABLE 4

| | PUSCH | | | |
|---|---|---|---|---|
| | mapping | | | |
| Row index | type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

Table 5 below shows an example of default PUSCH time domain resource allocation A for extended CP.

TABLE 5

| | PUSCH | | | |
|---|---|---|---|---|
| | mapping | | | |
| Row index | type | K₂ | S | L |
| 1 | Type A | j | 0 | 8 |
| 2 | Type A | j | 0 | 12 |
| 3 | Type A | j | 0 | 10 |
| 4 | Type B | j | 2 | 10 |
| 5 | Type B | j | 4 | 4 |
| 6 | Type B | j | 4 | 8 |
| 7 | Type B | j | 4 | 6 |
| 8 | Type A | j + 1 | 0 | 8 |
| 9 | Type A | j + 1 | 0 | 12 |
| 10 | Type A | j + 1 | 0 | 10 |
| 11 | Type A | j + 2 | 0 | 6 |
| 12 | Type A | j + 2 | 0 | 12 |
| 13 | Type A | j + 2 | 0 | 10 |
| 14 | Type B | j | 8 | 4 |
| 15 | Type A | j + 3 | 0 | 8 |
| 16 | Type A | j + 3 | 0 | 10 |

In the following, the CG-UCI are introduced.

When a UE is set to multiplex HARQ-ACK information in a PUSCH transmission that is configured by a ConfiguredGrantConfig, and includes CG-UCI as specified in the 3GPP TS 38.212: (a) if the UE is provided with cg-UCI-Multiplexing, the UE may multiplex the HARQ-ACK information in the PUSCH transmission, (b) if the HARQ-ACK information and the PUSCH have the same priority index, the UE may not transmit the PUSCH and multiplex the HARQ-ACK information in a PUCCH transmission or in another PUSCH transmission, and (c) if the HARQ-ACK information and the PUSCH have different priority indexes, the UE may not transmit the channel with the smaller priority index.

If the PUSCH transmission is with a configured grant and the UE is provided with CG-UCI-OnPUSCH=‘semiStatic’, the UE may apply the

$${β}_{offset}^{HARQ - ACK} , {β}_{offset}^{CSI - 1} , and {β}_{offset}^{CSI}$$

values that are provided by CG-UCI-OnPUSCH=‘semiStatic’ for the corresponding HARQ-ACK information, Part 1 CSI reports and Part 2 CSI reports. If the PUSCH transmission has priority 0 or priority 1 and the UE is configured by UCI-MuxWithDifferentPriority to multiplex HARQ-ACK information of priority 1 or priority 0, respectively, and if the UE multiplexes HARQ-ACK information of priority 1 or priority 0, the UE may apply corresponding

$${β}_{offset}^{HARQ - ACK , 1} or {β}_{offset}^{HARQ - ACK , 0}$$

provided by CG-betaOffsetsCrossPri1=‘semiStatic’ or CG-betaOffsetsCrossPri0=‘semiStatic’, respectively.

If the PUSCH transmission is scheduled by DCI format 0_0 and the UE is provided betaOffsets=‘dynamic’, the UE applies the

$${β}_{offset}^{HARQ - ACK} , {β}_{offset}^{CSI - 1} , and {β}_{offset}^{CSI - 2}$$

values that are determined from the first value of betaOffsets=‘dynamic’. If the UE is configured by UCI-MuxWithDifferentPriority to multiplex HARQ-ACK information of priority 1, the UE applies corresponding

$${β}_{offset}^{HARQ - ACK , 1}$$

provided by the first value of betaOffset-CrossPri1=‘dynamic’.

If the PUSCH transmission is a configured grant Type 2 PUSCH and the UE is provided with CG-UCI-OnPUSCH=‘dynamic’, the UE may apply the

$${β}_{offset}^{HARQ - ACK} , {β}_{offset}^{CSI - 1} , and {β}_{offset}^{CSI -}$$

values that are determined from the first value of CG-UCI-OnPUSCH=‘dynamic’. If the PUSCH transmission has priority 0 or priority 1 and the UE is configured by UCI-MuxWithDifferentPriority to multiplex HARQ-ACK information of priority 1 or priority 0, respectively, and if the UE multiplexes HARQ-ACK information of priority 1 or priority 0, the UE may apply corresponding

$${β}_{offset}^{HARQ - ACK , 1} or {β}_{offset}^{HARQ - ACK , 0}$$

provided by the first value of CG-betaOffsetsCrossPri1=‘dynamic’ or CG-betaOffsetsCrossPri0=‘dynamic’, respectively.

For a PUSCH transmission that is configured by a ConfiguredGrantConfig and includes CG-UCI, the UE may multiplex CG-UCI in the PUSCH transmission if the UE is provided by betaOffsetCG-UCI with a

$${I}_{offset}^{CG - UCI}$$

value, from a set of values, with the mapping as specified in the 3GPP TS 38.214. If the UE is provided with cg-UCI-Multiplexing and the multiplexes the HARQ-ACK information in the PUSCH transmission, as specified in the 3GPP TS 38.214, the UE may jointly encode the HARQ-ACK information and the CG-UCI as specified in the 3GPP TS 38.212 and determine a number of resources for multiplexing the combined information in a PUSCH using

$${β}_{offset}^{HARQ - ACK}$$

which provides indexes

$${I}_{offset , 1}^{HARQ - ACK} and {I}_{offset , 2}^{HARQ - ACK}$$

for the UE to use if the UE multiplexes up to 11, and more than 11 combined information bits, respectively.

In the following, the downlink feedback information (DFI) is introduced.

A UE may be configured with a number of search space sets to monitor PDCCH for detecting a DCI format 0_1 with a DFI flag field and CRC scrambled with a CS-RNTI provided by cs-RNTI. If a PUSCH transmission is configured by ConfiguredGrantConfig, the UE may determine that the DCI format provides the HARQ-ACK information for the PUSCH transmissions based on a DFI flag field value set to ‘1’.

The HARQ-ACK information may correspond to transport blocks in PUSCH transmissions for all HARQ processes for a serving cell of a PDCCH reception. The PDCCH reception may provide DCI format 0_1, and if DCI format 0_1 includes a carrier indicator field, the serving cell may be indicated by a value of the carrier indicator field.

For a PUSCH transmission configured by ConfiguredGrantConfig, HARQ-ACK information for a transport block of a corresponding HARQ process number is valid if a first symbol of the PDCCH reception is after a last symbol of the PUSCH transmission or a last symbol of any repetition of the PUSCH transmission, by a number of symbols provided by cg-minDFI-Delay.

For an initial transmission of a transport block in a PUSCH configured by ConfiguredGrantConfig, if the UE receives a CG-DFI that provides HARQ-ACK information for the transport block, the UE may assume that the transport block was correctly decoded if the HARQ-ACK information value is ACK; otherwise, the UE may assume that the transport block was not correctly decoded.

For a PUSCH transmission scheduled by a DCI format, if the UE receives a CG-DFI that provides HARQ-ACK information for the transport block, the UE may assume that the transport block was correctly decoded if the HARQ-ACK information value is ACK; otherwise, the UE may assume that the transport block was not correctly decoded.

For a PUSCH transmission scheduled by a DCI format, HARQ-ACK information for a transport block of a corresponding HARQ process number may be valid if a first symbol of the PDCCH reception is after a last symbol of the PUSCH transmission by a number of symbols provided by cg-minDFI-Delay. If the PUSCH transmission scheduled by a DCI format is over multiple slots and a value of HARQ information is ACK, the HARQ-ACK information for a transport block of a corresponding HARQ process number may be valid if a first symbol of the PDCCH reception is after a last symbol of the PUSCH transmission in a first slot from the multiple slots by a number of symbols provided by cg-minDFI-Delay.

If the PUSCH transmission scheduled by a DCI format is over multiple slots, a first symbol of PDCCH reception is after a last symbol of the PUSCH transmission in a last slot from the multiple slots by a number of symbols provided by cg-minDFI-Delay, and a value of HARQ-ACK information is NACK, the HARQ-ACK information for a transport block of a corresponding HARQ process number may be valid.

The UE may not expect to be configured with different cg-minDFI-Delay-r16 among multiple ConfiguredGrantConfig IEs in one BWP.

In Rel-18, eXtended Reality (XR) and Cloud Gaming (CG) may be some of the most important applications with low latency and high throughput requirements. The XR and CG use cases may be characterized by quasi-periodic traffic (with possible jitter) with high data rate in DL (e.g., video steam) combined with the frequent UL (e.g., pose/control update) and/or UL video stream. Both DL and UL traffic may be also characterized by relatively strict packet delay budget (PDB). The PDB may be a limited time budget for a packet to be transmitted over the air from a gNB to a UE.

For a given packet, the delay of the packet incurred in air interface may be measured from the time that the packet arrives at the gNB to the time that it is successfully transferred to the UE. If the delay is larger than a given PDB for the packet, the packet may be said to violate PDB; otherwise, the packet may be said to be successfully delivered. The value of PDB may vary for different XR applications.

Considering the XR traffic, the XR traffic may have varying packet size, which the XR packet size might be very small to very large, and with possible jitter. So that to accommodate XR traffic appropriately, dynamic scheduling may be considered. However, some of additional signaling, such as DCIs, UCIs, SR, BSR or MAC CEs may be needed for the dynamic scheduling, which may cause longer latency. The PDB may be an important factor while considering XR traffic. Thus, dynamic scheduling with longer latency caused by additional signaling may not be the top preference.

Another solution that may be considered to accommodate XR traffic is configured grant (CG) PUSCH, which the parameters are configured via RRC message. The actual CG PUSCH(s) may either be configured by RRC (Type 1) or activated by the DCI (Type 2). By CG PUSCH(s), additional signaling, such as DCIs, UCIs, SR, BSR or MAC CEs may no more needed for the scheduling. To solve latency issue, provide denser PUSCH occasions (or CG PUSCH occasions) in a specific period (or in a CG periodicity), so that the UE may transmit data/control on the (CG) PUSCH immediately. There may be some possible methods to accomplish denser (CG) PUSCH occasions, such as a CG configuration providing more than one PUSCH occasions and more than one CG configurations are provided in a specific period.

However, the configuration of denser PUSCH occasions (or CG PUSCH occasions) may give rise to a problem of PUSCH over-provisioning. Specifically, the NW/gNB may need to monitor/decode unused (CG) PUSCH resources. Different from other UL traffic, the XR traffic may have large packet size with low latency requirement, over-provisioning of CG PUSCHs (or CG occasions) may cost more severe resource waste comparing to other type of traffic. Therefore, it may be crucial to address the wastage of (CG) PUSCH resources that occurs when providing denser PUSCH (or CG PUSCH) occasions within a specific period.

In order to address the issue of CG PUSCH (or CG occasions) over-provisioning, it may be beneficial to provide information related to unused CG PUSCHs (or CG occasions) to the gNB. What information should be carried in the information may be further considered. Considering CG PUSCH is an UL traffic, only the UE may know the uplink traffic, carrying/multiplexing/transmitting information which related to how long should the information last for may be included in the information. If only a limited amount of CG PUSCH data needs to be transmitted, the UE may tell the gNB not to monitor certain CG PUSCHs (or CG occasions), either for specified periodicities or for a designated number of symbols, slots, or milliseconds.

In some implementation, a CG configuration may provide more than one PUSCH occasion. To provide denser CG occasions in a specific period, the UE may be configured with more than one CG occasions in a CG configuration (e.g., ConfiguredGrantConfig).

For type 1 CG configuration, the repetition type may be either PUSCH repetition type A or PUSCH repetition type B, and more than one time domain resource allocations may be configured (e.g., by RRC parameter timeDomainAllocation). Specifically, for PUSCH repetition type A, the selection of the more than one time domain resource allocation may follow the rules for DCI format 0_0 on UE specific search space. For PUSCH repetition type B, the selection of the more than one time domain resource allocation may be as follows:

If pusch-RepTypeIndicatorDCI-0-1 in pusch-Config is configured and set to ‘pusch-RepTypeB’, pusch-TimeDomainAllocationListDCI-0-1 in pusch-Config may be used; otherwise, pusch-TimeDomainAllocationListDCI-0-2 in pusch-Config may be used.

It may not be expected that pusch-RepTypeIndicator in rrc-ConfiguredUplinkGrant is configured with ‘pusch-RepTypeB’ when neither pusch-RepTypeIndicatorDCI-0-1 nor pusch-RepTypeIndicatorDCI-0-2 in pusch-Config are set to ‘pusch-RepTypeB’.

The higher layer parameter (e.g., timeDomainAllocation) value m may provide a row index m+1 pointing to a determined time domain resource allocation and/or pointing to a determined time domain resource allocation list. The UE may determine the time domain resource allocation and/or the time domain resource allocation list based on pusch-TimeDomainAllocationList (pusch-TimeDomainAllocationList-r16, pusch-TimeDomainAllocationListDCI-0-1, pusch-TimeDomainAllocationListDCI-0-2, pusch-TimeDomainAllocationList-ForMultiPUSCH, and/or pusch-TimeDomainAllocationList-ForMultiPUSCH-17) and/or in pusch-ConfigCommon and/or pusch-Config. In some implementations, the UE may determine the time domain resource allocation and/or the time domain resource allocation list based on a default table. Each time domain resource allocation in the time domain resource allocation list may be configured with at least one of mapping type, starting symbol, length, startSymbolAndLength, numberOfRepetitions, K2, numberOfSlots-TBoMS, periodicity, and offset. The row index m+1 may point to the determined time domain resource allocation list which includes more than one time domain resource allocation.

For type 2 CG configuration, more than one time domain resource allocation may be indicated by an activation DCI. The UE may determine the time domain resource allocation and/or the time domain resource allocation list based on the activation DCI. Specifically, The UE may determine the time domain resource allocation and/or the time domain resource allocation list based on the activation format (e.g., DCI format 0_1 and/or 02) and/or RNTI (e.g., CS-RNTI and/or C-RNTI). In some implementations, the UE may determine the time domain resource allocation and/or the time domain resource allocation list based on a default table. Each time domain resource allocation in the time domain resource allocation list may be configured with at least one of mapping type, starting symbol, length, startSymbolAndLength, numberOfRepetitions, K2, numberOfSlots-TBoMS, periodicity, and offset.

In some implementations, more than one CG configuration may be provided in a specific period.

In order to facilitate denser CG occasions within a specific period, it may be considered to configure more than one CG configuration, such as through the use of ConfiguredGrantConfig. The IE ConfiguredGrantConfig may be used to configure uplink transmission without DCI based on two possible schemes. The actual uplink grant may either be configured via RRC (type 1 CG configuration) or provided via the PDCCH (addressed to CS-RNTI) (type 2 CG configuration). Multiple CG configurations may be configured in one BWP of a serving cell (e.g., configuredGrantConfigToAddModList indicates a list of one or more configured grant configurations to be added or modified for one BWP). Each CG configuration may be configured with a periodicity.

One or more offsets may be configured in a CG configuration, the one or more offsets may represent the shifts in unit of symbols/slots of the configured CG occasions. For example, a CG configuration may be configured with a mapping type, starting symbol equals to 0, length equals to 2, periodicity equals to 112 symbols (or 8 slots with 14 symbols in each slot) which may be indicated by a parameter “sym8×14,” no repetition, and a K2 which should be transmitted in slot n. Then, the CG occasions may be transmitted on symbol 0, 1 in slot n, n+8, n+16, . . . , n+8*m and so on. If the one or more offsets is provided, 2 symbols for example, the CG occasions may be transmitted on symbol 2, 3 in slot n, n+8, n+16, . . . , n+8*m and so on. If the one or more offsets is provided, 2 slots for example, the CG occasions may be transmitted on symbol 0, 1 in slot n+2, n+8+2, n+16+2, . . . , n+8*m+2 and so on.

In the following, the unused PUSCH resource indication is introduced.

The UCI or cg-UCI may piggyback on the CG PUSCH (or a CG occasions). To indicate one or more unused CG occasions, the indication may be carried/transmitted by the UCI or cg-UCI. the UCI or cg-UCI may carry information corresponding to unused CG occasions. The UCI or cg-UCI corresponding to the unused CG occasion information may be piggybacked on a CG PUSCH (or a CG occasions).

In some implementations, if a UE is provided with one or more CG PUSCHs (or CG occasions) in a CG configuration, the UE may piggyback/multiplex/transmit the UCI or cg-UCI corresponding to the unused CG occasion information in the first CG PUSCH (or the first CG occasion).

If a UE is configured with more than one CG PUSCH (or CG occasion) by a CG configuration with CG type 1 configuration, the UCI or cg-UCI corresponding to the unused CG occasion information may be multiplexed in the first (actual) CG PUSCH (or CG occasion) of the more than one CG PUSCH (or CG occasion). If a UE is configured with more than one CG PUSCH (or CG occasion) by a CG configuration and the CG configuration is activated by an activation DCI (which is CG type 2 configuration), the UCI or cg-UCI corresponding to the unused CG occasion information may be multiplexed in the first (actual) CG PUSCH (or CG occasion) of the more than one CG PUSCH (or CG occasion).

If a UE is configured with more than one CG PUSCH (or CG occasion) by more than one CG configuration by a CG type 1 configuration, the UCI or cg-UCI corresponding to the unused CG occasion information may be multiplexed in the first (actual) CG PUSCH (or CG occasion) of the more than one CG PUSCH (or CG occasions) in a specific period. If a UE is configured with more than one CG PUSCH (or CG occasion) by more than one CG configuration and the more than one CG configuration is activated by one or more activation DCIs (which is CG type 2 configuration), the UCI or cg-UCI corresponding to the unused CG occasion information may be multiplexed in the first (actual) CG PUSCH (or CG occasion) of the more than one CG PUSCH (or CG occasion) in a specific period.

In some implementations, if a UE is provided with one or more CG PUSCHs (or CG occasions) in a CG configuration, the UE may piggyback/multiplex/transmit the UCI or cg-UCI corresponding to the unused CG occasion information in the last CG PUSCH (or the last CG occasion).

If a UE is configured with more than one CG PUSCH (or CG occasion) by a CG configuration with CG type 1 configuration, the UCI or cg-UCI corresponding to the unused CG occasion information may be multiplexed in the last (actual) CG PUSCH (or CG occasion) of the more than one CG PUSCH (or CG occasion). If a UE is configured with more than one CG PUSCH (or CG occasion) by a CG configuration and the CG configuration is activated by an activation DCI (which is CG type 2 configuration), the UCI or cg-UCI corresponding to the unused CG occasion information may be multiplexed in the last (actual) CG PUSCH (or CG occasion) of the more than one CG PUSCH (or CG occasion).

If a UE is configured more than one CG PUSCHs (, or CG occasions) by more than one CG configuration by a CG type 1 configuration, the UCI or cg-UCI corresponding to the unused CG occasion information may be multiplexed in the last (actual) CG PUSCH (or CG occasion) of the more than one CG PUSCH (or CG occasion) in a specific period. If a UE is configured more than one CG PUSCH (or CG occasion) by more than one CG configuration and the more than one CG configuration is activated by one or more activation DCIs (which is CG type 2 configuration), the UCI or cg-UCI corresponding to the unused CG occasion information may be multiplexed in the last (actual) CG PUSCH (or CG occasion) of the more than one CG PUSCH (or CG occasion) in a specific period.

In some implementations, if a UE is provided with one or more CG PUSCHs (or CG occasions) in a CG configuration, the UE may piggyback/multiplex/transmit the UCI or cg-UCI corresponding to the unused CG occasion information in every CG PUSCH (or every occasion).

If a UE is configured more than one CG PUSCH (or CG occasion) by a CG configuration by a CG type 1 configuration, the UCI or cg-UCI corresponding to the unused CG occasion information may be multiplexed in every (actual) CG PUSCH (or CG occasion) of the more than one CG PUSCH (or CG occasion). If a UE is configured more than one CG PUSCH (or CG occasion) by a CG configuration and the CG configuration is activated by an activation DCI (which is CG type 2 configuration), the UCI or cg-UCI corresponding to the unused CG occasion information may be multiplexed in every (actual) CG PUSCH (or CG occasion) of the more than one CG PUSCH (or CG occasion).

If a UE is configured more than one CG PUSCH (or CG occasion) by more than one CG configuration by a CG type 1 configuration, the UCI or cg-UCI corresponding to the unused CG occasion information may be multiplexed in every (actual) CG PUSCH (or CG occasion) of the more than one CG PUSCH (or CG occasion) in a specific period. If a UE is configured more than one CG PUSCH (or CG occasion) by more than one CG configuration and the more than one CG configuration is activated by one or more activation DCIs (which is CG type 2 configuration), the UCI or cg-UCI corresponding to the unused CG occasion information may be multiplexed in every (actual) CG PUSCH (or CG occasion) of the more than one CG PUSCH (or CG occasion) in a specific period.

In some implementations, if a UE is provided with one or more CG PUSCHs (or CG occasions) in a CG configuration, the UE may piggyback/multiplex/transmit the UCI or cg-UCI corresponding to the unused CG occasion information in the CG PUSCH (or the CG occasion) indicated by a (activation) DCI.

If a UE is configured more than one CG PUSCH (or CG occasion) by a CG configuration and the CG configuration is activated by activation DCI (which is CG type 2 configuration), the UCI or cg-UCI corresponding to the unused CG occasion information may be multiplexed in the CG PUSCH (or CG occasion) of the more than one CG PUSCH (or CG occasion) corresponding to an indication in the activation DCI. Specifically, if a UE is configured/provided with more than one CG PUSCH (or CG occasion) in a CG configuration and the UE detects the activation DCI with an information field indicating which CG occasion includes the UCI or cg-UCI corresponding to the unused CG occasion information, the UE may piggyback/multiplex/transmit the UCI or cg-UCI corresponding to the unused CG occasion information based on the information field.

If a UE is configured more than one CG PUSCH (or CG occasion) by more than one CG configuration and the more than one CG configuration is activated by one or more activation DCIs (which is CG type 2 configuration), the UCI or cg-UCI may correspond to the unused CG configuration(s) of the more than one CG configuration in a specific period which is indicated by one or more indications in the one or more activation DCIs respectively. One or some CG configuration IDs may be indicated by the one or more activation DCIs. If a UE is configured/provided with more than one CG configuration and the UE detects activation DCI with an information field indicating whether the CG configuration activated by the activation DCI includes the UCI or cg-UCI corresponding to the unused CG occasion information, the UE may piggyback/multiplex/transmit the UCI or cg-UCI corresponding to the unused CG occasion information based on the information field.

In some implementations, if a UE is provided with one or more CG PUSCHs (or CG occasions) in a CG configuration, the UE may piggyback/multiplex/transmit the UCI or cg-UCI corresponding to the unused CG occasion information in the CG PUSCH (or the CG occasion) configured by higher layer.

If a UE is configured more than one CG PUSCH (or CG occasion) by a CG configuration, the UCI or cg-UCI corresponding to the unused CG occasion information may be multiplexed in one CG PUSCH (or CG occasion) of the more than one CG PUSCH (or CG occasion). If the one CG PUSCH (or CG occasion) of the more than one CG PUSCH (or CG occasion) is configured in the higher layer parameter (e.g., RRC) or is provided by the higher layer (e.g., RRC), the UE may piggyback/multiplex/transmit the UCI or cg-UCI corresponding to the unused CG occasion information in the one CG PUSCH (or CG occasion).

If a UE is configured more than one CG PUSCH (or CG occasion) by more than one CG configuration, the UCI or cg-UCI may correspond to the unused CG configuration(s) of the more than one CG configuration in a specific period which is configured by a higher later parameter. If the one CG configuration of the more than one CG configuration is configured in the higher layer (e.g., RRC) or is provided by the higher layer parameter (e.g., RRC), the UE may piggyback/multiplex/transmit the UCI or cg-UCI corresponding to the unused CG occasion information in the one CG configuration.

The actual CG PUSCH (or CG occasion) may be an actual (CG) PUSCH transmission. A UE may transmit/carry data/information in the actual (CG) PUSCH transmission.

Information in the UCI or cg-UCI may indicate the unused CG PUSCH (or CG occasion).

The UCI or cg-UCI corresponding to the unused CG occasion information may include one or more of the following (a)-(s).
(a) a bitmap indicating that one or more CG PUSCHs (or CG occasions) are unused or used,
(b) a bitmap indicating that one or more CG configurations are unused or used,
(c) indication/information indicating that the CG PUSCH (or CG occasion) is the last CG PUSCH (or CG occasion),
(d) a bitmap indicating that the CG PUSCH (or CG occasion) in the specific minislot(s) (e.g., 2-symbol slot or 7-symbol slot) does not need to be monitored,
(e) a bitmap indicating that the CG PUSCH (or CG occasion) in the specific slot(s) does not need to be monitored,
(f) a bitmap indicating that the CG PUSCH (or CG occasion) in the specific frequency(s) does not need to be monitored,
(g) indication/information indicating that the CG PUSCH (or CG occasion) in the specific minislot(s) (e.g., 2-symbol slot or 7-symbol slot) does not need to be monitored,
(h) indication/information indicating that the CG PUSCH (or CG occasion) after the specific minislot(s) (e.g., 2-symbol slot or 7-symbol slot) does not need to be monitored,
(i) indication/information indicating that the CG PUSCH (or CG occasion) in the specific minislot(s) (e.g., 2-symbol slot or 7-symbol slot) needs to be monitored,
(j) indication/information indicating that the CG PUSCH (or CG occasion) before the specific minislot(s) (e.g., 2-symbol slot or 7-symbol slot) needs to be monitored,
(k) indication/information indicating that the CG PUSCH (or CG occasion) in the specific slot(s) does not need to be monitored,
(l) indication/information indicating that the CG PUSCH (or CG occasion) after the specific slot(s) does not need to be monitored,
(m) indication/information indicating that the CG PUSCH (or CG occasion) in the specific slot(s) needs to be monitored,
(n) indication/information indicating that the CG PUSCH (or CG occasion) before the specific slot(s) needs to be monitored,
(o) indication/information indicating that there are (total) n1 number of CG PUSCHs (or CG occasions) are used to transmit (CG) PUSCH,
(p) indication/information indicating that the last/first n2 number of CG PUSCHs (or CG occasions) are not used to transmit (CG) PUSCH,
(q) a duration of the UCI and/or cg-UCI that is applied,
(r) a number of periodicities that the UCI and/or cg-UCI is applied, and
(s) a number of symbols/slots/msec that the UCI and/or cg-UCI is applied.

In some implementations, if a UE is configured/provided with 6 CG PUSCHs (or CG occasions) in a CG configuration, the UE piggybacks/multiplexes/transmits the UCI or cg-UCI corresponding to the unused CG occasion information in the first (actual) CG PUSCH (or CG occasion), and the value of the information included in the UCI or cg-UCI is “110010,” the UE may not transmit the CG PUSCH on the second, third and fifth CG PUSCHs (or CG occasions) indicated by the activation DCI.

In some implementations, if a UE is configured/provided with n CG PUSCHs (or CG occasions) in 6 (consecutive or non-consecutive) slots in a CG configuration, the UE piggybacks/multiplexes/transmits the UCI or cg-UCI corresponding to the unused CG occasion information in the first (actual) CG PUSCH (or CG occasion), and the value of the information included in the UCI or cg-UCI is “110010,” the UE may not transmit the CG PUSCH in the second, third and fifth slots indicated by the activation DCI.

In some implementations, if a UE is configured/provided with 6 CG PUSCHs (or CG occasions) in a CG configuration, the UE piggybacks/multiplexes/transmits the UCI or cg-UCI corresponding to the unused CG occasion information in the first (actual) CG PUSCH (or CG occasion), and the value of the information included in the UCI or cg-UCI is “2,” the UE may not transmit the CG PUSCH on the last 2 CG PUSCHs (or CG occasions). In other words, only the first 4 CG PUSCHs (or CG occasions) may be used to transmit the (CG) PUSCH and the last 2 CG PUSCHs (or CG occasions) may not be used to transmit the (CG) PUSCH.

In some implementations, if a UE is configured/provided with 6 CG PUSCHs (or CG occasions) in a CG configuration, the UE piggybacks/multiplexes/transmits the UCI or cg-UCI corresponding to the unused CG occasion information in the first (actual) CG PUSCH (or CG occasions), and the value of the information included in the UCI or cg-UCI is “5,” the UE may use (first) 5 CG PUSCHs (or CG occasions) in total. In other words, only the first 5 CG PUSCHs (or CG occasions) may be used to transmit the (CG) PUSCH and the last CG PUSCH (or CG occasion) may not be used to transmit (CG) PUSCH.

In some implementations, if a UE is configured/provided with 6 CG PUSCHs (or a number of CG occasions) in a CG configuration, the CG configuration indicates that periodicity is m symbols, the UE piggybacks/multiplexes/transmits the UCI or cg-UCI corresponding to the unused CG occasion information in the first (actual) CG PUSCH (or CG occasion), the unused CG occasion information includes the last 2 CG PUSCHs (or last 2 CG occasions) that are unused CG PUSCHs (or CG occasions), and the UCI (or cg-UCI, or the unused CG occasion information, or the higher layer) indicates that 4 periodicities is applied, the UE may use (first) 4 CG PUSCHs (or CG occasions) in total for 4 periodicities (e.g., 4*m symbols). In other words, the UE may not use the last 2 CG occasions to transmit CG PUSCH for 4 periodicities (e.g., 4*m symbols).

A number of periodicities (or a number of CG PUSCHs) may be configured in a CG configuration. The UCI or cg-UCI corresponding to the unused CG occasion information may include one of the number of periodicities configured in CG configuration. For example, if a number of periodicities {1,2,4,8} is configured in the CG configuration, the UE may include information corresponding to one of the number of periodicities (e.g., 2) in the UCI or cg-UCI, and the UE may apply unused CG PUSCHs (or CG occasions) information included in the UCI or cg-UCI for 2 CG periodicities. The UCI or cg-UCI may also correspond to the unused CG occasion information.

If a UE is configured/provided with more than one CG PUSCH (or CG occasion) in a CG configuration, the UE detects an activation DCI including an information field, and the information field indicates the at least one of the following (a)-(g) for one or more unused CG occasions, the UE may not transmit CG PUSCH on the one or more unused CG occasions indicated by the activation DCI.
(a) CG occasion ID,
(b) Offset,
(c) K2,
(d) SLIV,
(e) Starting symbol,

(f) Length, and
(g) Bitmap

In some implementations, if a UE is configured/provided with 6 CG PUSCHs (or CG occasions) in a CG configuration, the UE detects an activation DCI including an information field, and the value of the information field is “110010,” the UE may not transmit CG PUSCH on the 2nd, 3rd, and 5th CG occasions indicated by the activation DCI. In some implementations, if a UE is configured/provided with 6 CG PUSCHs (or CG occasions) in a CG configuration with 4 different offsets (e.g., 2, 4, 6, and 8), the UE detects an activation DCI including an information field, and the value of the information field is “1” (or “01”), the UE may not transmit CG PUSCH with the offset 4 (e.g., the value of the information field “1” (or “01”) maps to offset 4).

If a UE is configured/provided with more than one CG configuration, the UE detects an activation DCI including an information field, and the information field indicates CG configuration IDs for one or more unused CG configurations, the UE may not transmit CG PUSCH corresponding to the one or more unused CG configurations indicated by the activation DCI. One or more CG configuration IDs may be indicated by the one or more activation DCIs.

The UCI corresponding to the unused CG occasion information may include one or more of the following (a)-(s).
(a) a bitmap indicating that one or more CG PUSCHs (or CG occasions) are unused or used. Each bit of the bitmap may indicate that one CG PUSCH (or CG occasion) of the one or more CG PUSCHs (or CG occasions) is unused or used.
(b) a bitmap indicating that one or more CG configurations are unused or used,
(c) indication/information indicating that the CG PUSCH (or CG occasion) is the last CG PUSCH (or CG occasion),
(d) a bitmap indicating that the CG PUSCH (or CG occasion) in the specific minislot(s) (e.g., 2-symbol slot or 7-symbol slot) does not needed to be monitored
(e) a bitmap indicating that the CG PUSCH (or CG occasion) in the specific slot(s) does not need to be monitored,
(f) a bitmap indicating that the CG PUSCH (or CG occasion) in the specific frequency(s) does not need to be monitored,
(g) indication/information indicating that the CG PUSCH (or CG occasion) in the specific minislot(s) (e.g., 2-symbol slot or 7-symbol slot) does not need to be monitored,
(h) indication/information indicating that the CG PUSCH (or CG occasion) after the specific minislot(s) (e.g., 2-symbol slot or 7-symbol slot) does not need to be monitored,
(i) indication/information indicating that the CG PUSCH (or CG occasion) in the specific minislot(s) (e.g., 2-symbol slot or 7-symbol slot) needs to be monitored,
(j) indication/information indicating that the CG PUSCH (or CG occasion) before the specific minislot(s) (e.g., 2-symbol slot or 7-symbol slot) needs to be monitored,
(k) indication/information indicating that the CG PUSCH (or CG occasion) in the specific slot(s) does not need to be monitored,
(l) indication/information indicating that the CG PUSCH (or CG occasion) after the specific slot(s) does not need to be monitored,
(m) indication/information indicating that the CG PUSCH (or CG occasion) in the specific slot(s) needs to be monitored,
(n) indication/information indicating that the CG PUSCH (or CG occasion) before the specific slot(s) needs to be monitored,
(o) indication/information indicating that there are (total) n1 number of CG PUSCHs (or CG occasions) are used to transmit (CG) PUSCH,
(p) indication/information indicating that the last/first n2 number of CG PUSCHs (or CG occasions) are not used to transmit (CG) PUSCH,
(q) a duration of the UCI and/or cg-UCI that is applied,
(r) a number of periodicities that the UCI and/or cg-UCI is applied, and
(s) a number of symbols/slots/msec that the UCI and/or cg-UCI is applied.

The UCI may be transmitted in a PUCCH. Specifically, the UE may transmit the PUCCH with the UCI corresponding to the unused CG occasion information to gNB.

The information corresponding to the unused CG occasion information may be transmitted to the gNB through the MAC CE and/or (DG) PUSCH. The information corresponding to the unused CG occasion information may include one or more of the following (a)-(s).
(a) a bitmap indicating that one or more CG PUSCHs (or CG occasions) are unused or used,
(b) a bitmap indicating that one or more CG configurations are unused or used,
(c) indication indicating that the CG PUSCH (or CG occasion) is the last CG PUSCH (or CG occasion),
(d) a bitmap indicating that the CG PUSCH (or CG occasion) in the specific minislot(s) (e.g., 2-symbol slot or 7-symbol slot) does not to be monitored,
(e) a bitmap indicating that the CG PUSCH (or CG occasion) in the specific slot(s) does not to be monitored,
(f) a bitmap indicating that the CG PUSCH (or CG occasion) in the specific frequency(s) does not to be monitored,
(g) indication indicating that the CG PUSCH (or CG occasion) in the specific minislot(s) (e.g., 2-symbol slot or 7-symbol slot) does not to be monitored,
(h) indication indicating that the CG PUSCH (or CG occasion) after the specific minislot(s) (e.g., 2-symbol slot or 7-symbol slot) does not to be monitored,
(i) indication indicating that the CG PUSCH (or CG occasion) in the specific minislot(s) (e.g., 2-symbol slot or 7-symbol slot) needs to be monitored,
(j) indication/indicating that the CG PUSCH (or CG occasion) before the specific minislot(s) (e.g., 2-symbol slot or 7-symbol slot) needs to be monitored,
(k) indication indicating that the CG PUSCH (or CG occasion) in the specific slot(s) does not to be monitored,
(l) indication indicating that the CG PUSCH (or CG occasion) after the specific slot(s) does not to be monitored,
(m) indication indicating that the CG PUSCH (or CG occasion) in the specific slot(s) needs to be monitored,
(n) indication indicating that the CG PUSCH (or CG occasion) before the specific slot(s) needs to be monitored,
(o) indication indicating that there are (total) n1 number of CG PUSCHs (or CG occasions) is used to transmit (CG) PUSCH,
(p) indication indicating that the last/first n2 number of CG PUSCHs (or CG occasions) are not used to transmit (CG) PUSCH,
(q) a duration of the UCI and/or cg-UCI that is applied,
(r) a number of periodicities that the UCI and/or cg-UCI is applied, and
(s) a number of symbols/slots/msec that the UCI and/or cg-UCI is applied.

The MAC CE may be transmitted in the first/last (actual) CG PUSCH (or CG occasion) of the more than one CG PUSCH (or CG occasion) configured by one or more CG configurations. The DG PUSCH may be a PDSCH scheduling by DCI. The DG PUSCH may not be activated by an activation DCI and/or configured by the RRC signaling.

After the UE transmits the information corresponding to the unused CG occasion information in a CG PUSCH (or in a CG occasion, or in a PUCCH, or in a MAC-CE, or in a DG PUSCH), the UE may not expect to detect/receive a gNB feedback in n1 symbols/slots/msec from the last symbol of the CG PUSCH (or CG occasion, or PUCCH, or MAC-CE, or DG PUSCH) that carries the information corresponding to the unused CG occasion information. In some implementations, the gNB feedback may be indicated by a specific field (e.g., DFI flag) in DCI. A new DCI field may be used to indicate the UE that one or more CG PUSCHs (or CG occasions) are well received or not well received by the gNB. In some implementations, the new DCI field may be a reused DCI field (e.g., HARQ-ACK bitmap). Specifically, n1 may be provided by a configured application delay corresponding to the downlink feedback.

For one or more CG PUSCH (or CG occasion) transmissions configured by one or more CG configurations, the information corresponding to the unused CG occasion information may be valid if a first symbol of the PDCCH reception is after a last symbol of the (CG) PUSCH that carries/multiplexes/transmits the information corresponding to the unused CG occasion information by a number of symbols provided by n1.

For an initial transmission of a transport block in a PUSCH configured by ConfiguredGrantConfig, if the UE receives a DCI field corresponding to one or more CG PUSCHs (or CG occasions) that provides the information corresponding to the unused CG occasion information, the UE may assume that the information was correctly decoded if the information value is ACK; otherwise, the UE may assume that the information was not correctly decoded.

In the following, the beta offset is introduced.

Offset values may be defined for a UE to determine a number of resources for multiplexing HARQ-ACK information and for multiplexing CSI reports in a PUSCH. The offset values may also be defined for multiplexing UCI (or CG-UCI) in a CG PUSCH (or CG occasion). The offset values may be signaled to a UE either by a DCI format scheduling the PUSCH transmission or by higher layers (e.g., betaOffsetCG-UCI).

If a UE is configured with more than one CG PUSCH (or CG occasion) by a CG configuration, the beta offset (e.g., betaOffsetCG-UCI) may be configured for each CG PUSCH (or CG occasion).

Table 6 below shows an example of the data structure of ConfiguredGrantConfig 1E.

TABLE 6

| | |
|---|---|
| ConfiguredGrantConfig ::= | SEQUENCE { |
| frequencyHopping | ENUMERATED {intraSlot, interSlot} |

OPTIONAL, -- Need S

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs- |

```
1),
    ...,
    [[
```

| | |
|---|---|
| pusch-RepTypeIndicator-r16 | ENUMERATED {pusch-RepTypeA,pusch-RepTypeB} |

OPTIONAL, -- Need M

| | |
|---|---|
| frequencyHoppingPUSCH-RepTypeB-r16 | ENUMERATED {interRepetition, interSlot} |

OPTIONAL, -- Cond RepTypeB

| | |
|---|---|
| timeReferenceSFN-r16 | ENUMERATED {sfn512} |

```
OPTIONAL -- Need S
    ]],
    [[
```

| | |
|---|---|
| pathlossReferenceIndex2-r17 | INTEGER (0..maxNrofPUSCH-PathlossReferenceRSs-1) |

OPTIONAL, -- Need R

| | |
|---|---|
| srs-ResourceIndicator2-r17 | INTEGER (0..15) |

OPTIONAL, -- Need R

| | |
|---|---|
| precodingAndNumberOfLayers2-r17 | INTEGER (0..63) |

OPTIONAL, -- Need R

| | |
|---|---|
| timeDomainAllocation-v1710 | INTEGER (16..63) |

OPTIONAL, -- Need M

| | |
|---|---|
| timeDomainOffset-r17 | INTEGER (0..40959) |

OPTIONAL, -- Need R

| | |
|---|---|
| cg-SDT-Configuration-r17 | CG-SDT-Configuration-r17 |

```
OPTIONAL -- Need M
    ]]
  }
OPTIONAL, -- Need R
  ...,
  [[
```

| | |
|---|---|
| cg-RetransmissionTimer-r16 | INTEGER (1..64) |

OPTIONAL, -- Need R

| | |
|---|---|
| cg-minDFI-Delay-r16 | ENUMERATED |
| | {sym7, sym1x14, sym2x14, sym3x14, |

sym4x14, sym5x14, sym6x14, sym7x14, sym8x14,

sym9x14, sym10x14, sym11x14,

sym12x14, sym13x14, sym14x14, sym15x14, sym16x14

}

OPTIONAL, -- Need R

| | |
|---|---|
| cg-nrofPUSCH-InSlot-r16 | INTEGER (1..7) |

OPTIONAL, -- Need R

| | |
|---|---|
| cg-nrofSlots-r16 | INTEGER (1..40) |

OPTIONAL, -- Need R

| | |
|---|---|
| cg-StartingOffsets-r16 | CG-StartingOffsets-r16 |

OPTIONAL, -- Need R

| | |
|---|---|
| cg-UCI-Multiplexing-r16 | ENUMERATED {enabled} |

OPTIONAL, -- Need R

| | |
|---|---|
| cg-COT-SharingOffset-r16 | INTEGER (1..39) |

OPTIONAL, -- Need R

| | |
|---|---|
| betaOffsetCG-UCI-r16 | INTEGER (0..31) |

OPTIONAL, -- Need R

| | |
|---|---|
| cg-COT-SharingList-r16 | SEQUENCE (SIZE (1..1709)) OF CG-COT-Sharing- |
| r16 | OPTIONAL, -- Need R |
| harq-ProcID-Offset-r16 | INTEGER (0..15) |

OPTIONAL, -- Need M

| | |
|---|---|
| harq-ProcID-Offset2-r16 | INTEGER (0..15) |

OPTIONAL, -- Need M

| | |
|---|---|
| configuredGrantConfigIndex-r16 | ConfiguredGrantConfigIndex-r16 |

OPTIONAL, -- Cond CG-List

| | |
|---|---|
| configuredGrantConfigIndexMAC-r16 | ConfiguredGrantConfigIndexMAC-r16 |

OPTIONAL, -- Cond CG-IndexMAC

| | |
|---|---|
| periodicityExt-r16 | INTEGER (1..5120) |

OPTIONAL, -- Need R

| | |
|---|---|
| startingFromRV0-r16 | ENUMERATED {on, off} |

OPTIONAL, -- Need R

| | |
|---|---|
| phy-PriorityIndex-r16 | ENUMERATED {p0, p1} |

OPTIONAL, -- Need R

| | |
|---|---|
| autonomousTx-r16 | ENUMERATED {enabled} |

```
OPTIONAL -- Cond LCH-BasedPrioritization
  ]],
  [[
```

| | |
|---|---|
| cg-betaOffsetsCrossPri0-r17 | SetupRelease { BetaOffsetsCrossPriSelCG-r17 } |

OPTIONAL, -- Need M

| | |
|---|---|
| cg-betaOffsetsCrossPri1-r17 | SetupRelease { BetaOffsetsCrossPriSelCG-r17 } |

OPTIONAL, -- Need M

| | |
|---|---|
| mappingPattern-r17 | ENUMERATED {cyclicMapping, sequentialMapping} |

OPTIONAL, -- Cond SRSsets

| | |
|---|---|
| sequenceOffsetForRV-r17 | INTEGER (0..3) |

OPTIONAL, -- Need R

| | |
|---|---|
| p0-PUSCH-Alpha2-r17 | P0-PUSCH-AlphaSetId |

OPTIONAL, -- Need R

| | |
|---|---|
| powerControlLoopToUse2-r17 | ENUMERATED {n0, n1} |

OPTIONAL, -- Need R

| | |
|---|---|
| cg-COT-SharingList-r17 | SEQUENCE (SIZE (1..50722)) OF CG-COT-Sharing- |
| r17 | OPTIONAL, -- Need R |
| periodicityExt-r17 | INTEGER (1..40960) |

OPTIONAL, -- Need R

| | |
|---|---|
| repK-v1710 | ENUMERATED {n12, n16, n24, n32} |

OPTIONAL, -- Need R

| | |
|---|---|
| nrofHARQ-Processes-v1700 | INTEGER(17..32) |

OPTIONAL, -- Need M

| | |
|---|---|
| harq-ProcID-Offset2-v1700 | INTEGER (16..31) |

OPTIONAL, -- Need R

| | |
|---|---|
| configuredGrantTimer-v1700 | INTEGER(33..288) |

OPTIONAL, -- Need R

| | |
|---|---|
| cg-minDFI-Delay-v1710 | INTEGER (238..3584) |

OPTIONAL -- Need R
]]
}
CG-UCI-OnPUSCH ::= CHOICE {

| | |
|---|---|
| dynamic | SEQUENCE (SIZE (1..4)) OF BetaOffsets, |
| semiStatic | BetaOffsets |

}
BetaOffsetsCrossPriSelCG-r17 ::= CHOICE {

| | |
|---|---|
| dynamic-r17 | SEQUENCE (SIZE (1..4)) OF BetaOffsetsCrossPri-r17, |
| semiStatic-r17 | BetaOffsetsCrossPri-r17, |

}

Table 7 below shows an example of the data structure of BWP-UplinkDedicated IE.

TABLE 7

| | |
|---|---|
| BWP-UplinkDedicated ::= | SEQUENCE { |
| pucch-Config | SetupRelease { PUCCH-Config } |

OPTIONAL, -- Need M

| | |
|---|---|
| pusch-Config | SetupRelease { PUSCH-Config } |

OPTIONAL, -- Need M

| | |
|---|---|
| configuredGrantConfig | SetupRelease { ConfiguredGrantConfig } |

OPTIONAL, -- Need M

| | |
|---|---|
| srs-Config | SetupRelease { SRS-Config } |

OPTIONAL, -- Need M

| | |
|---|---|
| beamFailureRecoveryConfig | SetupRelease { BeamFailureRecoveryConfig } |

```
OPTIONAL, -- Cond SpCellOnly
  ...,
  [[
```

| | |
|---|---|
| sl-PUCCH-Config-r16 | SetupRelease { PUCCH-Config } |

OPTIONAL, -- Need M

| | |
|---|---|
| cp-ExtensionC2-r16 | INTEGER (1..28) |

OPTIONAL, -- Need R

| | |
|---|---|
| cp-ExtensionC3-r16 | INTEGER (1..28) |

OPTIONAL, -- Need R

| | |
|---|---|
| useInterlacePUCCH-PUSCH-r16 | ENUMERATED {enabled} |

OPTIONAL, -- Need R

| | |
|---|---|
| pucch-ConfigurationList-r16 | SetupRelease { PUCCH-ConfigurationList-r16 } |

OPTIONAL, -- Need M

| | |
|---|---|
| lbt-FailureRecoveryConfig-r16 | SetupRelease { LBT-FailureRecoveryConfig-r16 } |

OPTIONAL, -- Need M
configuredGrantConfigToAddModList-r16

| | |
|---|---|
| ConfiguredGrantConfigToAddModList-r16 | OPTIONAL, -- Need N |

configuredGrantConfigToReleaseList-r16

| | |
|---|---|
| ConfiguredGrantConfigToReleaseList-r16 | OPTIONAL, -- Need N |

configuredGrantConfigType2DeactivationStateList-r16

| | |
|---|---|
| ConfiguredGrantConfigType2DeactivationStateList-r16 | OPTIONAL -- Need R |

```
  ]],
  [[
```

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF |
| TCI-UL-State-r17 | OPTIONAL, -- Need N |
| ul-TCI-ToReleaseList-r17 | SEQUENCE (SIZE (1..maxUL-TCI-r17)) OF TCI- |
| UL-State-Id-r17 | OPTIONAL -- Need N |

},

| | |
|---|---|
| unifiedTCI-StateRef-r17 | ServingCellAndBWP-Id-r17 |

}
OPTIONAL, -- Need R

| | |
|---|---|
| ul-powerControl-r17 | Uplink-powerControlId-r17 |

OPTIONAL, -- Cond NoTCI-PC

| | |
|---|---|
| pucch-ConfigurationListMulticast1-r17 | SetupRelease { PUCCH-ConfigurationList-r16 } |

OPTIONAL, -- Need M

| | |
|---|---|
| pucch-ConfigurationListMulticast2-r17 | SetupRelease { PUCCH-ConfigurationList-r16 } |

OPTIONAL -- Need M
]]
}

Table 8 below shows an example of the data structure of UCI-OnPUSCH IE.

TABLE 8

| | |
|---|---|
| UCI-OnPUSCH ::= | SEQUENCE { |
| betaOffsets | CHOICE { |
| dynamic | SEQUENCE (SIZE (4)) OF BetaOffsets, |
| semiStatic | BetaOffsets |

}
OPTIONAL, -- Need M

| | |
|---|---|
| scaling | ENUMERATED { f0p5, f0p65, f0p8, f1 } |

}

| | |
|---|---|
| MinSchedulingOffsetK2-Values-r16 ::= | SEQUENCE (SIZE (1..maxNrOfMinSchedulingOffsetValues- |

r16)) OF INTEGER (0..maxK2-SchedulingOffset-r16)

| | |
|---|---|
| MinSchedulingOffsetK2-Values-r17 ::= | SEQUENCE (SIZE (1..maxNrOfMinSchedulingOffsetValues- |

r16)) OF INTEGER (0..maxK2-SchedulingOffset-r17)

| | |
|---|---|
| UCI-OnPUSCH-DCI-0-2-r16 ::= | SEQUENCE { |
| betaOffsetsDCI-0-2-r16 | CHOICE { |
| dynamicDCI-0-2-r16 | CHOICE { |
| oneBit-r16 | SEQUENCE (SIZE (2)) OF BetaOffsets, |
| twoBits-r16 | SEQUENCE (SIZE (4)) OF BetaOffsets |

},

| | |
|---|---|
| semiStaticDCI-0-2-r16 | BetaOffsets |

}
OPTIONAL, -- Need M

| | |
|---|---|
| scalingDCI-0-2-r16 | ENUMERATED { f0p5, f0p65, fop8, f1 } |

}

| | |
|---|---|
| FrequencyHoppingOffsetListsDCI-0-2-r16 ::= | SEQUENCE (SIZE (1..4)) OF INTEGER (1.. |

maxNrofPhysicalResourceBlocks-1)

| | |
|---|---|
| UCI-OnPUSCH-ListDCI-0-2-r16 ::= | SEQUENCE (SIZE (1..2)) OF UCI-OnPUSCH-DCI-0-2-r16 |
| UCI-OnPUSCH-ListDCI-0-1-r16 ::= | SEQUENCE (SIZE (1..2)) OF UCI-OnPUSCH |

In the following, the PDCCH validation for DL SPS and UL grant Type 2 which also known as activation/deactivation DCI is introduced.

A UE may validate, for scheduling activation or scheduling release, a DL SPS assignment PDCCH or a configured UL grant Type 2 PDCCH if
(a) the CRC of a corresponding DCI format is scrambled with a CS-RNTI provided by cs-RNTI or a G-CS-RNTI provided by g-cs-RNTI,
(b) the new data indicator field in the DCI format for the enabled transport block is set to ‘0’,
(c) the DFI flag field, if present, in the DCI format is set to ‘0’,
(d) the time domain resource assignment field in the DCI format indicates a row with single SLIV, and
(e) the PDSCH-to-HARQ_feedback timing indicator field does not provide an inapplicable value from dl-DataToUL-ACK-r16 if validation is for scheduling activation and the PDSCH-to-HARQ_feedback timing indicator field in the DCI format is present.

If a UE is provided with a single configuration for UL grant Type 2 PUSCH or for SPS PDSCH, the validation of the DCI format may be achieved if all fields for the DCI format are set as specified in the 3GPP TS 38.213. If a UE is provided with more than one configuration for UL grant Type 2 PUSCH or for SPS PDSCH, a value of the HARQ process number field in a DCI format may indicate an activation for a corresponding UL grant Type 2 PUSCH or for a SPS PDSCH configuration with a same value as provided by ConfiguredGrantConfiglndex or by sps-ConfigIndex, respectively. The validation of the DCI format may be achieved if the RV field for the DCI format is set as in as specified in the 3GPP TS 38.213.

If a UE is provided with more than one configuration for UL grant Type 2 PUSCH or for SPS PDSCH:
(a) a value of the HARQ process number field in a DCI format may indicate a corresponding entry for scheduling release of one or more UL grant Type 2 PUSCH or SPS PDSCH configurations if the UE is provided with ConfiguredGrantConfigType2DeactivationStateList or sps-ConfigDeactivationStateList,
(b) a value of the HARQ process number field in a DCI format may indicate a release for a corresponding UL grant Type 2 PUSCH or for a SPS PDSCH configuration with a same value as provided by ConfiguredGrantConfigIndex or by sps-ConfigIndex respectively if the UE is not provided with ConfiguredGrantConfigType2DeactivationStateList or sps-ConfigDeactivationStateList.

The validation of the DCI format may be achieved if all fields for the DCI format are set as specified in the 3GPP TS 38.213.

If the validation is achieved, the UE may consider the information in the DCI format as a valid activation or valid release of DL SPS or configured UL grant Type 2. If the validation is not achieved, the UE may discard all of the information in the DCI format.

Table 9 below shows an example of special fields for single DL SPS or single UL grant Type 2 scheduling activation PDCCH validation when a UE is provided with a single SPS PDSCH or UL grant Type 2 configuration in the active DL/UL BWP of the scheduled cell.

TABLE 9

| | DCI format | DCI format | DCI format |
|---|---|---|---|
| | 0_0/0_1/0_2 | 1_0/1_2/4_1 | 1_1/4_2 |
| HARQ process | set to all ‘0’s | set to all ‘0’s | set to all ‘0’s |
| number | | | |
| Redundancy | set to all ‘0’s | set to all ‘0’s | For the enabled |
| version | | | transport block: |
| | | | set to all ‘0’s |

Table 10 below shows an example of special fields for single DL SPS or single UL grant Type 2 scheduling release PDCCH validation when a UE is provided a single SPS PDSCH or UL grant Type 2 configuration in the active DL/UL BWP of the scheduled cell.

TABLE 10

| | DCI format | DCI format |
|---|---|---|
| | 0_0/0_1/0_2 | 1_0/1_1/1_2/4_1/4_2 |
| HARQ process number | set to all ‘0’s | set to all ‘0’s |
| Redundancy version | set to all ‘0’s | set to all ‘0’s |
| Modulation and coding | set to all ‘1’s | set to all ‘1’s |
| scheme | | |
| Frequency domain | set to all | set to all ‘0’s for FDRA |
| resource assignment | ‘0’s for FDRA | Type 0 or for |
| | Type 2 with μ = 1 | dynamicSwitch |
| | set to all ‘1’s, | set to all ‘1’s for FDRA |
| | otherwise | Type 1 |

Table 11 below shows an example of special fields for a single DL SPS or single UL grant Type 2 scheduling activation PDCCH validation when a UE is provided with multiple DL SPS or UL grant Type 2 configurations in the active DL/UL BWP of the scheduled cell.

TABLE 11

| | DCI format | DCI format | DCI format |
|---|---|---|---|
| | 0_0/0_1/0_2 | 1_0/1_2/4_1 | 1_1/4_2 |
| Redundancy | set to all ‘0’s | set to all ‘0’s | For the enabled transport |
| version | | | block: set to all ‘0’s |

Table 12 below shows an example of special fields for a single or multiple DL SPS and UL grant Type 2 scheduling release PDCCH validation when a UE is provided with multiple DL SPS or UL grant Type 2 configurations in the active DL/UL BWP of the scheduled cell.

TABLE 12

| | DCI format | DCI format |
|---|---|---|
| | 0_0/0_1/0_2 | 1_0/1_1/1_2/4_1/4_2 |
| Redundancy | set to all ‘0’s | set to all ‘0’s |
| version | | |
| Modulation and | set to all ‘1’s | set to all ‘1’s |
| coding scheme | | |
| Frequency | set to all ‘0’s for | set to all ‘0’s for FDRA |
| domain | FDRA Type 2 with μ = 1 | Type 0 or for dynamicSwitch |
| resource | set to all ‘1’s, | set to all ‘1’s for |
| assignment | otherwise | FDRA Type 1 |

A UE may be expected to provide HARQ-ACK information in response to a SPS PDSCH release after N symbols from the last symbol of a PDCCH providing the SPS PDSCH release. If processingType2Enabled of PDSCH-ServingCellConfig is set to enable for the serving cell with the PDCCH providing the SPS PDSCH release, N=5 for p=0, N=5.5 for p=1, and N=11 for p=2, otherwise, N=10 for p=0, N=12 for p=1, N=22 for p=2, N=25 for p=3, N=100 for p=5, and N=200 for p=6, wherein y corresponds to the smallest SCS configuration between the SCS configuration of the PDCCH providing the SPS PDSCH release and the SCS configuration of a PUCCH carrying the HARQ-ACK information in response to a SPS PDSCH release.

Another issue is that configuration of resource allocation of CG is semi-static. Specifically, configuration of denser CG PUSCH occasions is semi-static. Thus, the CG configuration may not adapt to the XR traffic packet sizes well. In this case, dynamically configuring the CG occasions or dynamically indicating/changing CG occasions may be considered. How to release (enhanced) configured grant PUSCH(s) (for at least type1, type 2 and other possible CG PUSCHs) may also be considered. The deactivation DCI for deactivating/releasing (type 2) CG PUSCH(s) indicating a list of configured CG configurations is not flexible. More flexible CG PUSCH activation/deactivation/releasing may be considered.

In the following, dynamically CG PUSCH activation/deactivation is introduced.

Each CG PUSCH (or CG occasion) of the one or more CG PUSCHs (or CG occasions) configured in a CG configuration may be activated/deactivated by a DCI (which may be activation/deactivation DCI, or scheduling DCI). In other words, one or more CG PUSCHs (or CG occasions) configured in the CG configuration may not be necessary to be activated/deactivated together.

In some implementations, for type 1 CG configuration, the one or more CG PUSCHs (or CG occasions) configured in a CG configuration may be activated/deactivated by (activation/deactivation) DCI. In some implementations, when one or more CG PUSCHs (or CG occasions) are configured in a (type 1) CG configuration, the UE receives/detects a PDCCH with a DCI, and a value and/or a bitmap and/or a configured activation/deactivation list is set in the DCI field (e.g., HARQ process number field) in the DCI that indicates an activation/deactivation for a corresponding one or more CG PUSCHs (or CG occasions) configured in the (type 1) CG configuration, the UE may transmit (CG) PUSCH transmission in the corresponding one or some CG PUSCHs (or CG occasions) indicated by the DCI.

In some implementations, for type 1 CG configuration, the one or more CG PUSCHs (or CG occasions) configured in a CG configuration may be activated/deactivated by (activation/deactivation) DCI. In some implementations, when one or more CG PUSCHs (or CG occasions) are configured in a (type 1) CG configuration, the UE receives/detects a PDCCH with a DCI, and a value and/or a bitmap and/or a configured activation/deactivation list is set in the DCI field (e.g., HARQ process number field) in the DCI that indicates an activation/deactivation for a corresponding one or more CG PUSCHs (or CG occasions) configured in the (type 1) CG configuration, the UE may not transmit (CG) PUSCH transmission in the corresponding one or some CG PUSCHs (or CG occasions) indicated by the DCI.

In some implementations, when 16 CG PUSCHs (or CG occasions) are configured in a (type 1) CG configuration, the UE receives/detects a PDCCH with DCI, and a value of the HARQ process number field is set to ‘0010’ in a DCI format, that indicates an activation/deactivation for 2 CG PUSCHs (or CG occasions) configured in the (type 1) CG configuration, the UE may transmit (CG) PUSCH transmission in the first 2 (activated/deactivated) CG PUSCHs (or CG occasions) of the total 16 CG PUSCHs (or CG occasions) configured by the CG configuration, or the UE may transmit (CG) PUSCH transmission in the 2^{nd} (activated/deactivated) CG PUSCH (or CG occasion) of the total 16 CG PUSCHs (or CG occasions) configured by the CG configuration.

In some implementations, when 16 CG PUSCHs (or CG occasions) are configured in a (type 1) CG configuration, the UE receives/detects a PDCCH with DCI, and a value of the HARQ process number field is set to ‘0010’ in a DCI format, that indicates an activation/deactivation for 2 CG PUSCHs (or CG occasions) configured in the (type 1) CG configuration, the UE may not transmit (CG) PUSCH transmission in the first 2 (activated/deactivated) CG PUSCHs (or CG occasions) of the total 16 CG PUSCHs (or CG occasions) configured by the CG configuration, or the UE may not transmit (CG) PUSCH transmission in the 2^{nd} (activated/deactivated) CG PUSCH (or CG occasion) of the total 16 CG PUSCHs (or CG occasions) configured by the CG configuration.

In some implementations, when 8 CG PUSCHs (or CG occasions) are configured in a (type 1) CG configuration, the UE receives/detects a PDCCH with DCI, and a bitmap in a DCI field is set to ‘00110010’ in the DCI, that indicates an activation/deactivation for the 3^{rd}, 4^{th} and 7^{th} CG PUSCHs (or CG occasions) configured in the (type 1) CG configuration, the UE may transmit (CG) PUSCH transmission in the 3^{rd}, 4^{th}, and 7^{th} CG PUSCHs (or CG occasions) of the total 8 CG PUSCHs (or CG occasions) configured by the CG configuration, or the UE may treats the 3rd, 4^{th}, and 7^{th} CG PUSCHs (or CG occasions) of the total 8 CG PUSCHs (or CG occasions) configured by the CG configuration as activated CG PUSCHs (CG occasions).

In some implementations, when 8 CG PUSCHs (or CG occasions) are configured in a (type 1) CG configuration, the UE receives/detects a PDCCH with DCI, and a bitmap in a DCI field is set to ‘00110010’ in the DCI, that indicates an activation/deactivation for the 3^{rd}, 4^{th} and 7^{th} CG PUSCHs (or CG occasions) configured in the (type 1) CG configuration, the UE may not transmit (CG) PUSCH transmission in the 3^{rd}, 4^{th}, and 7^{th} CG PUSCHs (or CG occasions) of the total 8 CG PUSCHs (or CG occasions) configured by the CG configuration, or the UE may treats the 3^{rd}, 4^{th}, and 7^{th} CG PUSCHs (or CG occasions) of the total 8 CG PUSCHs (or CG occasions) configured by the CG configuration as deactivated CG PUSCHs (CG occasions).

In some implementations, when 8 CG PUSCHs (or CG occasions), more than one (e.g., 4) activation/deactivations list are configured in a (type 1) CG configuration, the UE receives/detects a PDCCH with DCI, and activation/deactivation list ID 1 is set in a DCI field in the DCI, the UE may transmit (CG) PUSCH transmission based on the CG PUSCHs (or CG occasions) indicated by the activation/deactivation list ID 1.

In some implementations, when 8 CG PUSCHs (or CG occasions), more than one (e.g., 4) activation/deactivations list are configured in a (type 1) CG configuration, the UE receives/detects a PDCCH with DCI, and activation/deactivation list ID 1 is set in a DCI field in the DCI, the UE may not transmit (CG) PUSCH transmission based on the CG PUSCHs (or CG occasions) indicated by the activation/deactivation list ID 1.

Each CG PUSCH (or CG occasion) of the one or more CG PUSCHs (or CG occasions) configured in a CG configuration may be activated/deactivated by an activation/deactivation DCI respectively. In other words, one or more CG PUSCHs (or CG occasions) configured in the CG configuration may not be necessary to be activated/deactivated together. In some implementations, the activation/deactivation DCI may also be scheduling DCI. The scheduling DCI may schedule one or more PDSCHs or PUSCHs. In some implementations, the scheduling DCI may not schedule one or more PDSCHs or PUSCHs.

For type 2 CG configuration, the one or more CG PUSCHs (or CG occasions) configured in a CG configuration and may be activated/deactivated by activation/deactivation DCI. In some implementations, when one or more CG PUSCHs (or CG occasions) are configured in a CG configuration, the UE receives/detects activation/deactivation DCI, and a value and/or a bitmap and/or a configured activation/deactivation list is set in the DCI field (e.g., HARQ process number field) in the activation/deactivation DCI that indicates an activation/deactivation for a corresponding one or more CG PUSCHs (or CG occasions) configured in the CG configuration, the UE may transmit (CG) PUSCH transmission in the corresponding one or more CG PUSCHs (or CG occasions) indicated by the activation/deactivation DCI.

In some implementations, when one or more CG PUSCHs (or CG occasions) are configured in a CG configuration, the UE receives/detects activation/deactivation DCI, and a value and/or a bitmap and/or a configured activation/deactivation list is set in the DCI field (e.g., HARQ process number field) in the activation/deactivation DCI that indicates an activation/deactivation for a corresponding one or more CG PUSCHs (or CG occasions) configured in the CG configuration, the UE may not transmit (CG) PUSCH transmission in the corresponding one or more CG PUSCHs (or CG occasions) indicated by the activation/deactivation DCI.

In some implementations, when 16 CG PUSCHs (or CG occasions) are configured in a CG configuration, the UE receives/detects activation/deactivation DCI, and a value of the HARQ process number field is set to ‘0010’ in the activation/deactivation DCI that indicates an activation/deactivation for 2 CG PUSCHs (or CG occasions) configured in the CG configuration, the UE may transmit (CG) PUSCH transmission in the first 2 (activated/deactivated) CG PUSCHs (or CG occasions) of the total 16 CG PUSCHs (or CG occasions) configured by the CG configuration, or the UE may transmit (CG) PUSCH transmission in the 2^{nd} (activated/deactivated) CG PUSCH (or CG occasion) of the total 16 CG PUSCHs (or CG occasions) configured by the CG configuration.

In some implementations, when 16 CG PUSCHs (or CG occasions) are configured in a CG configuration, the UE receives/detects activation/deactivation DCI, and a value of the HARQ process number field is set to ‘0010’ in the activation/deactivation DCI that indicates an activation/deactivation for 2 CG PUSCHs (or CG occasions) configured in the CG configuration, the UE may not transmit (CG) PUSCH transmission in the first 2 (activated/deactivated) CG PUSCHs (or CG occasions) of the total 16 CG PUSCHs (or CG occasions) configured by the CG configuration, or the UE may not transmit (CG) PUSCH transmission in the 2^{nd} (activated/deactivated) CG PUSCH (or CG occasion) of the total 16 CG PUSCHs (or CG occasions) configured by the CG configuration.

In some implementations, when 8 CG PUSCHs (or CG occasions) are configured in a CG configuration, the UE receives/detects activation/deactivation DCI, a bitmap in a DCI field is set to ‘00110010’, and the activation/deactivation DCI indicates an activation/deactivation for the 3^{rd}, 4^{th}, and 7^{th} CG PUSCHs (or CG occasions) configured in the (type 1) CG configuration, the UE may transmit (CG) PUSCH transmission in the 3^{rd}, 4^{th}, and 7^{th} CG PUSCHs (or CG occasions) of the total 8 CG PUSCHs (or CG occasions) configured by the CG configuration, or the UE may treat the 3^{rd}, 4^{th}, and 7^{th} CG PUSCHs (or CG occasions) of the total 8 CG PUSCHs (or CG occasions) configured by the CG configuration as activated CG PUSCHs (CG occasions).

In some implementations, when 8 CG PUSCHs (or CG occasions) are configured in a CG configuration, the UE receives/detects activation/deactivation DCI, a bitmap in a DCI field is set to ‘00110010’, and the activation/deactivation DCI indicates an activation/deactivation for the 3^{rd}, 4^{th}, and 7^{th} CG PUSCHs (or CG occasions) configured in the (type 1) CG configuration, the UE may not transmit (CG) PUSCH transmission in the 3^{rd}, 4^{th}, and 7^{th} CG PUSCHs (or CG occasions) of the total 8 CG PUSCHs (or CG occasions) configured by the CG configuration, or the UE may treat the 3^{rd}, 4^{th} and 7^{th} CG PUSCHs (or CG occasions) of the total 8 CG PUSCHs (or CG occasions) configured by the CG configuration as deactivated CG PUSCHs (CG occasions).

In some implementations, when 8 CG PUSCHs (or CG occasions), more than one (e.g., 4) activation/deactivation lists are configured in a CG configuration, the UE receives/detects activation/deactivation DCI, and an activation/deactivation list ID 1 is set in a DCI field in the activation/deactivation DCI, the UE may transmit (CG) PUSCH transmission based on the CG PUSCHs (or CG occasions) indicated by the activation/deactivation list ID 1.

In some implementations, when 8 CG PUSCHs (or CG occasions), more than one (e.g., 4) activation/deactivation lists are configured in a CG configuration, the UE receives/detects activation/deactivation DCI, and an activation/deactivation list ID 1 is set in a DCI field in the activation/deactivation DCI, the UE may not transmit (CG) PUSCH transmission based on the CG PUSCHs (or CG occasions) indicated by the activation/deactivation list ID 1.

Each CG PUSCH (or CG occasion) of the one or more CG PUSCHs (or CG occasions) configured in one or more CG configurations may be activated/deactivated by activation/deactivation DCI. In other words, one or more CG PUSCHs (or CG occasions) configured in the one or more CG configurations may be activated/deactivated by single (activation/deactivation) DCI. In some implementations, when one or more CG PUSCHs (or CG occasions) are configured in one or more CG configurations, the UE receives/detects activation/deactivation DCI, and a value and/or a bitmap and/or a configured activation/deactivation list is set in the DCI field in the activation/deactivation DCI that indicates an activation/deactivation for a corresponding one or some CG configurations, the UE may transmit (CG) PUSCH transmission in the corresponding one or some CG configurations indicated by the activation/deactivation DCI.

In some implementations, when one or more CG PUSCHs (or CG occasions) are configured in one or more CG configurations, the UE receives/detects activation/deactivation DCI, and a value and/or a bitmap and/or a configured activation/deactivation list is set in the DCI field in the activation/deactivation DCI that indicates an activation/deactivation for a corresponding one or some CG configurations, the UE may not transmit (CG) PUSCH transmission in the corresponding one or some CG configurations indicated by the activation/deactivation DCI.

In some implementations, the activation/deactivation DCI may also be scheduling DCI. In some implementations, the scheduling DCI may schedule one or more PDSCHs or PUSCHs. In some implementations, the scheduling DCI may not schedule one or more PDSCHs or PUSCHs.

In some implementations, when 16 CG configurations, the UE receives/detects activation/deactivation DCI, and a value of the HARQ process number field is set to ‘0010’ in the activation/deactivation DCI that indicates an activation/deactivation for 2 CG configurations, the UE may transmit (CG) PUSCH transmission in the first 2 (activated/deactivated) CG configurations of the total 16 CG configurations, or the UE may transmit (CG) PUSCH transmission in the 2^{nd} (activated/deactivated) CG configuration of the total 16 CG configurations.

In some implementations, when 16 CG configurations, the UE receives/detects activation/deactivation DCI, and a value of the HARQ process number field is set to ‘0010’ in the activation/deactivation DCI that indicates an activation/deactivation for 2 CG configurations, the UE may not transmit (CG) PUSCH transmission in the first 2 (activated/deactivated) CG configurations of the total 16 CG configurations, or the UE may not transmit (CG) PUSCH transmission in the 2^{nd} (activated/deactivated) CG configuration of the total 16 CG configurations.

In some implementations, when 8 CG configurations are configured, the UE receives/detects activation/deactivation DCI, a bitmap in a DCI field is set to ‘00110010’, and the activation/deactivation DCI indicates an activation/deactivation for the 3^{rd}, 4^{th}, and 7^{th} CG configurations, the UE may transmit (CG) PUSCH transmission in the 3^{rd}, 4^{th}, and 7^{th} CG configurations of the total 8 CG configurations, or the UE may treats the 3^{rd}, 4^{th} and 7^{th} CG configurations of the total 8 CG configurations as activated CG configurations.

In some implementations, when 8 CG configurations are configured, the UE receives/detects activation/deactivation DCI, a bitmap in a DCI field is set to ‘00110010’, and the activation/deactivation DCI indicates an activation/deactivation for the 3^{rd}, 4^{th}, and 7^{th} CG configurations, the UE may not transmit (CG) PUSCH transmission in the 3^{rd}, 4^{th}, and 7^{th} CG configurations of the total 8 CG configurations, or the UE may treats the 3^{rd}, 4^{th}, and 7^{th} CG configurations of the total 8 CG configurations as deactivated CG configurations.

In some implementations, when 8 CG configurations, more than one (e.g., 4) activation/deactivation lists are configured, the UE receives/detects activation/deactivation DCI, and an activation/deactivation list ID 1 is set in a DCI field in the activation/deactivation DCI, the UE may transmit (CG) PUSCH transmission based on the CG configurations indicated by the activation/deactivation list ID 1.

In some implementations, when 8 CG configurations, more than one (e.g., 4) activation/deactivation lists are configured, the UE receives/detects activation/deactivation DCI, and an activation/deactivation list ID 1 is set in a DCI field in the activation/deactivation DCI, the UE may not transmit (CG) PUSCH transmission based on the CG configurations indicated by the activation/deactivation list ID 1.

The activation/deactivation DCI for activating/deactivating one or more CG PUSCHs (or CG occasions) may include a DCI field indicating the number of periodicities, that indicates the number of periodicities the activation/deactivation indication applies.

In some implementations, when 8 CG PUSCHs (or CG occasions) and a number (e.g., 4) of periodicities {1,2,4,8} are configured in a CG configuration, the UE receives/detects activation/deactivation DCI, a bitmap corresponding to activation/deactivation in a DCI field is set to ‘00110010’, an indication corresponding to the number (e.g., 4) of periodicities {1,2,4,8} is set to ‘11’ (e.g., periodicity {8} is indicated), and the activation/deactivation DCI indicates an activation/deactivation for the 3^{rd}, 4^{th} and 7^{th} CG PUSCHs (or CG occasions) configured in the CG configuration, the UE may transmit (CG) PUSCH transmission in the 3^{rd}, 4^{th} and 7^{th} CG PUSCHs (or CG occasions) of the total 8 CG PUSCHs (or CG occasions) configured by the CG configuration for 8 periodicities, or the UE may treats the 3^{rd}, 4^{th} and 7^{th} CG PUSCHs (or CG occasions) of the total 8 CG PUSCHs (or CG occasions) configured by the CG configuration as activated CG PUSCHs (CG occasions) for 8 periodicities.

In some implementations, when 8 CG PUSCHs (or CG occasions) and a number (e.g., 4) periodicities {1,2,4,8} are configured in a CG configuration, the UE receives/detects activation/deactivation DCI, a bitmap corresponding to activation/deactivation in a DCI field is set to ‘00110010’, an indication corresponding to the number (e.g., 4) of periodicities {1,2,4,8} is set to ‘11’ (e.g., periodicity {8} is indicated), and the activation/deactivation DCI indicates an activation/deactivation for the 3^{rd}, 4^{th} and 7^{th} CG PUSCHs (or CG occasions) configured in the CG configuration, the UE may not transmit (CG) PUSCH transmission in the 3^{rd}, 4^{th} and 7^{th} CG PUSCHs (or CG occasions) of the total 8 CG PUSCHs (or CG occasions) configured by the CG configuration for 8 periodicities, or the UE may treats the 3^{rd}, 4^{th}, and 7^{th} CG PUSCHs (or CG occasions) of the total 8 CG PUSCHs (or CG occasions) configured by the CG configuration as deactivated CG PUSCHs (CG occasions) for 8 periodicities.

In some implementations, when 8 CG configurations and each includes a number of periodicities are configured (wherein the 6^{th} CG configuration includes a configuration of number of periodicities {1,2,4,8}), the UE receives/detects activation/deactivation DCI, and an indication in a DCI field is set to ‘101’, an indication corresponding to the number of periodicities {1,2,4,8} is set to ‘11’ (e.g., periodicity {8} is indicated), and the activation/deactivation DCI indicates an activation/deactivation for the 6^{th} CG configuration for 8 periodicities, the UE may transmit (CG) PUSCH transmission in the 6^{th} CG configurations of the total 8 CG configurations for 8 periodicities, or the UE may treats the 6^{th} CG configuration of the total 8 CG configurations as activated CG configurations for 8 periodicities.

In some implementations, when 8 CG configurations and each includes a number of periodicities are configured (wherein the 6^{th} CG configuration includes a configuration of number of periodicities {1,2,4,8}), the UE receives/detects activation/deactivation DCI, and an indication in a DCI field is set to ‘101’, an indication corresponding to the number of periodicities {1,2,4,8} is set to ‘11’ (e.g., periodicity {8} is indicated), and the activation/deactivation DCI indicates an activation/deactivation for the 6^{th} CG configuration for 8 periodicities, the UE may not transmit (CG) PUSCH transmission in the 6^{th} CG configurations of the total 8 CG configurations for 8 periodicities, or the UE may treats the 6^{th} CG configuration of the total 8 CG configurations as deactivated CG configurations for 8 periodicities.

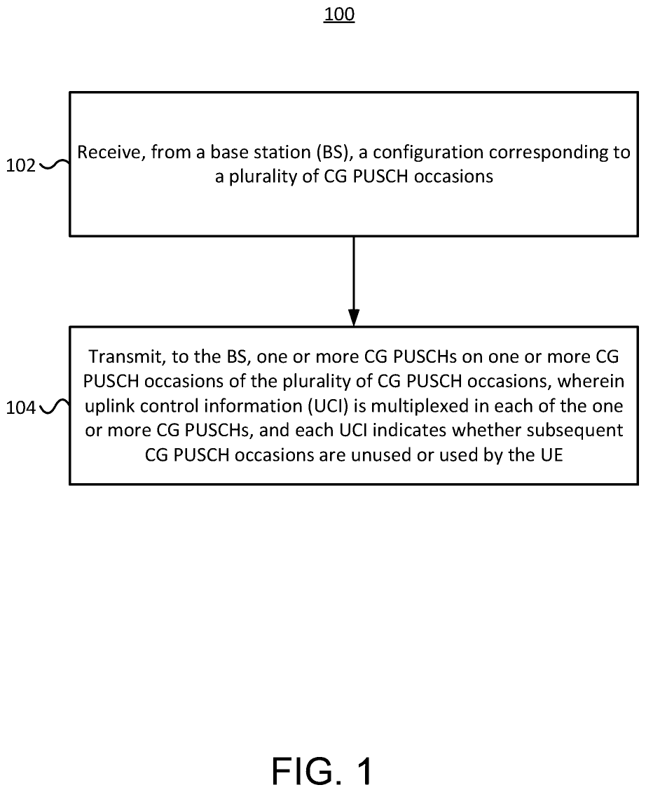

FIG. 1 is a flowchart 100 illustrating a method for configured grant (CG) physical uplink shared channel (PUSCH) transmissions performed by a UE, according to an example implementation of the present disclosure.

In action 102, the UE may receive, from a base station (BS), a configuration corresponding to a plurality of CG PUSCH occasions.

In action 104, the UE may transmit, to the BS, one or more CG PUSCHs on one or more CG PUSCH occasions of the plurality of CG PUSCH occasions. Uplink control information (UCI) may be multiplexed in each of the one or more CG PUSCHs, and each UCI may indicate whether subsequent CG PUSCH occasions are unused or used by the UE.

In some implementations, the each UCI may include a bitmap indicating whether the subsequent CG PUSCH occasions are unused or used by the UE. In some implementations, the configuration may include a parameter applied for the each UCI, and the each UCI may indicate, based on the parameter, whether a number of the subsequent CG PUSCH occasions are unused or used by the UE. The parameter may include a periodicity. In some implementations, a beta-offset may be configured for each of the one or more CG PUSCHs, and the UCI may be multiplexed in each of the one or more CG PUSCHs based on the beta-offset. In some implementations, the beta-offset configured for each of the one or more CG PUSCHs may be different.

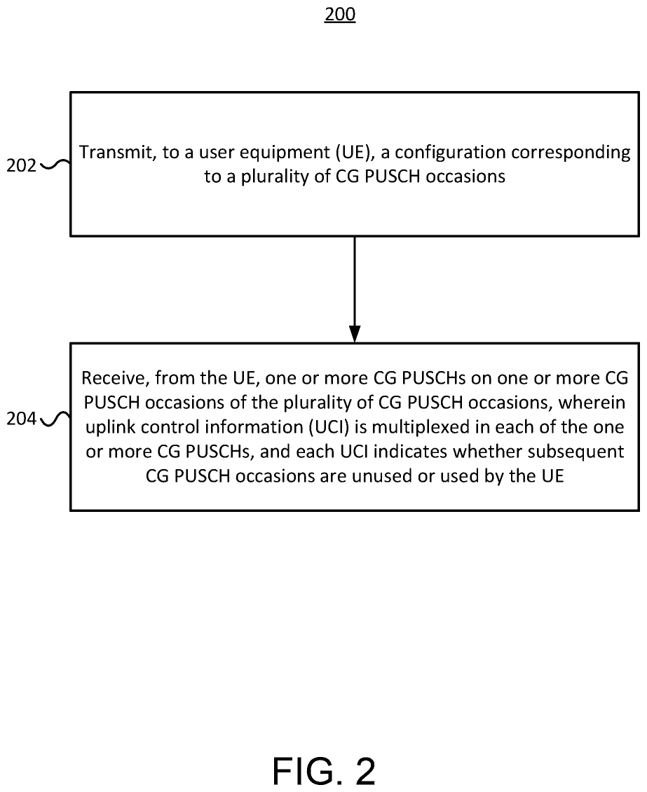

FIG. 2 is a flowchart 200 illustrating a method for CG PUSCH transmissions performed by a BS, according to an example implementation of the present disclosure.

In action 202, the BS may transmit, to a user equipment (UE), a configuration corresponding to a plurality of CG PUSCH occasions.

In action 204, the BS may receive, from the UE, one or more CG PUSCHs on one or more CG PUSCH occasions of the plurality of CG PUSCH occasions. Uplink control information (UCI) may be multiplexed in each of the one or more CG PUSCHs, and each UCI may indicate whether subsequent CG PUSCH occasions are unused or used by the UE.

In some implementations, the each UCI may include a bitmap indicating whether the subsequent CG PUSCH occasions are unused or used by the UE. In some implementations, the configuration may include a parameter applied for the each UCI, and the each UCI may indicate, based on the parameter, whether a number of the subsequent CG PUSCH occasions are unused or used by the UE. The parameter may include a periodicity. In some implementations, a beta-offset may be configured for each of the one or more CG PUSCHs, and the UCI may be multiplexed in each of the one or more CG PUSCHs based on the beta-offset. In some implementations, the beta-offset configured for each of the one or more CG PUSCHs may be different.

The technical problem addressed by the present disclosure is the efficient utilization and management of network resources during CG PUSCH transmissions. Traditional systems might not effectively communicate the status of CG PUSCH occasions, which can lead to the inefficient utilization of network bandwidth as the base station might allocate resources for CG PUSCH occasions that are not utilized by the UE. Moreover, it seeks to address the challenge of achieving an optimal balance between the transmission of data and the conservation of bandwidth by reducing unnecessary monitoring and decoding of unused resources.

The present disclosure brings several advantageous technical effects to the fore:
(a) Improved Network Efficiency: By enabling the UE to indicate whether subsequent CG PUSCH occasions are unused or used, it allows for a more dynamic and flexible resource allocation. This means that the base station can reallocate resources more optimally based on the real-time requirements of the UE, thereby enhancing the overall network efficiency.
(b) Reduced Resource Wastage: As the UE transmits information about the usage status of CG PUSCH occasions through UCI, it helps in avoiding wastage of network resources. The base station does not have to monitor or allocate resources for unused CG PUSCH occasions, thus conserving bandwidth and potentially reducing latency in the network.
(c) Enhanced User Experience: The method provided in the present disclosure allows for a smoother and more adaptive communication experience for the user. By having a system that can quickly adapt to changing conditions and requirements, it ensures that the user equipment can maintain a stable and reliable connection, enhancing the overall user experience.
(d) Facilitated Network Planning and Management: Through the method provided in the present disclosure, network operators have better insights into the real-time status of CG PUSCH occasions, which can be instrumental in planning and managing network resources more effectively. It aids in foreseeing potential network congestions and taking necessary actions in time to prevent them.

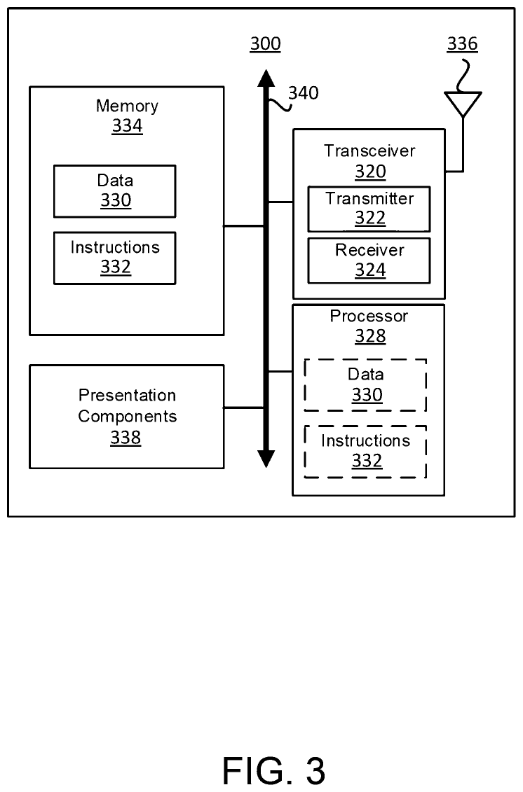

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 and 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 and 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A user equipment (UE) performing configured grant (CG) physical uplink shared channel (PUSCH) transmissions, the UE comprising:
at least one processor; and
at least one non-transitory computer-readable medium coupled to the at least one processor and storing one or more computer-executable instructions that, when executed by the at least one processor, cause the UE to:
receive, from a base station (BS), a configuration corresponding to a plurality of CG PUSCH occasions; and
transmit, to the BS, one or more CG PUSCHs on one or more CG PUSCH occasions of the plurality of CG PUSCH occasions, wherein:
uplink control information (UCI) is multiplexed in each of the one or more CG PUSCHs, and
each UCI indicates whether subsequent CG PUSCH occasions are unused or used by the UE.

2. The UE of claim 1, wherein each UCI comprises a bitmap indicating whether the subsequent CG PUSCH occasions are unused or used by the UE.

3. The UE of claim 1, wherein:
the configuration comprises a parameter applied to each UCI, and
each UCI indicates, based on the parameter, whether a number of the subsequent CG PUSCH occasions are unused or used by the UE.

4. The UE of claim 1, wherein:
a beta-offset is configured for each of the one or more CG PUSCHs, and
the UCI is multiplexed in each of the one or more CG PUSCHs based on the beta-offset.

5. The UE of claim 4, wherein the beta-offset configured for each of the one or more CG PUSCHs is different.

6. A method for configured grant (CG) physical uplink shared channel (PUSCH) transmissions performed by a user equipment (UE), the method comprising:
receiving, from a base station (BS), a configuration corresponding to a plurality of CG PUSCH occasions; and
transmitting, to the BS, one or more CG PUSCHs on one or more CG PUSCH occasions of the plurality of CG PUSCH occasions, wherein:
uplink control information (UCI) is multiplexed in each of the one or more CG PUSCHs, and
each UCI indicates whether subsequent CG PUSCH occasions are unused or used by the UE.

7-10. (canceled)

11. Abase station (BS) for configured grant (CG) physical uplink shared channel (PUSCH) transmissions, the BS comprising:
at least one processor; and
at least one non-transitory computer-readable medium coupled to the at least one processor and storing one or more computer-executable instructions that, when executed by the at least one processor, cause the BS to:
transmit, to a user equipment (UE), a configuration corresponding to a plurality of CG PUSCH occasions; and
receive, from the UE, one or more CG PUSCHs on one or more CG PUSCH occasions of the plurality of CG PUSCH occasions, wherein:
uplink control information (UCI) is multiplexed in each of the one or more CG PUSCHs, and
each UCI indicates whether subsequent CG PUSCH occasions are unused or used by the UE.

12. The BS of claim 11, wherein each UCI comprises a bitmap indicating whether the subsequent CG PUSCH occasions are unused or used by the UE.

13. The BS of claim 11, wherein:
the configuration comprises a parameter applied to each UCI, and
each UCI indicates, based on the parameter, whether a number of the subsequent CG PUSCH occasions are unused or used by the UE.

14. The BS of claim 11, wherein:
a beta-offset is configured for each of the one or more CG PUSCHs, and
the UCI is multiplexed in each of the one or more CG PUSCHs based on the beta-offset.

15. The BS of claim 14, wherein the beta-offset configured for each of the one or more CG PUSCHs is different.
